(19) United States
(12) Patent Application Publication
(10) Pub. No.: US 2025/0206881 A1
(43) Pub. Date: Jun. 26, 2025

(54) MODIFIED LYSINE-BASED POLYMER AND COMPOSITIONS COMPRISING THE SAME

(71) Applicant: BASF SE, Ludwigshafen Am Rhein (DE)

(72) Inventors: Alexandros LAMPROU, Shanghai (CN); Yuyu WU, Shanghai (CN); Shi Jie ZHOU, Shanghai (CN); Dieter BOECKH, Ludwigshafen am Rhein (DE); Juergen DETERING, Ludwigshafen am Rhein (DE); Fei Mo SHI, Shanghai (CN); Zhen Yuan QU, Shanghai (CN); Dustin D. HAWKER, Wyandotte, MI (US); Daniel Scott NIEDZWIECKI, Florham Park, NJ (US)

(21) Appl. No.: 18/844,524

(22) PCT Filed: Apr. 4, 2023
(86) PCT No.: PCT/CN2023/086218

§ 371 Date: Sep. 6, 2024

(30) Foreign Application Priority Data
Apr. 6, 2022 (WO) PCT/CN2022/085333

(51) Int. Cl. C08G 69/10; C08G 69/48; C11D 3/20; C11D 3/37; C11D 3/48

(52) U.S. Cl. CPC C08G 69/10; C08G 69/48; C11D 3/2068; C11D 3/3719; C11D 3/48

(57) ABSTRACT

Disclosed herein are a modified lysine-based polymer obtained from a process including Michael addition of at least a portion of free amino groups in a lysine-based polymer with a Michael acceptor selected from the group consisting of at least one of unsaturated carboxylic acids and unsaturated carboxylic acid esters, and a detergent composition including the same. Further disclosed herein are a method of preserving an aqueous detergent composition including the modified lysine-based polymer, and a method of laundering fabric or cleaning hard surfaces using the detergent composition including the modified lysine-based polymer.

### FIELD OF THE INVENTION

The present invention relates to a modified lysine-based polymer, a detergent composition comprising the same and use of the modified lysine-based polymer in detergent compositions, particularly as a dispersing agent.

### BACKGROUND ART

Nowadays, dispersing agents play an important role in various industrial and household formulations, for example in laundry detergent formulations for prevention of greying of textile. Dispersing efficacy to avoid undesirable phenomena such as scaling or soil depositing, for example in washing, cleaning processes were always pursued for the development of dispersing agents.

Most of dispersing agents used today are petroleum-based rather than bio-based. Recently, bio-based products and products comprising bio-based ingredients have increasingly attracted consumer's interest due to the sustainability of biomass resource. With such a trend, bio-based dispersing agents bring new challenges for the manufacturers, in particular in household detergent applications.

WO2021228642A1 discloses use of carboxymethylated polylysines as a dispersing agent. The carboxymethylated polylysines are manufactured from biodegradable polylysines through modification for example with chloroacetic acid salt. Although the carboxymethylated polylysines show acceptable anti-greying performance, the manufacture thereof has disadvantages in that sodium chloroacetate is toxic and corrosive. Residue of the modification agent chloroacetic acid salt in the final product shall be limited strictly due to its toxity. Additionally, vessels made from special and expensive materials are required to handle the chloroacetate due to its corrosion.

There is thus a need to provide a biodegradable chemical as dispersing agents useful in industrial and household formulations. It will be more desirable if the biodegradable dispersing agents may be manufactured from less toxic and corrosive materials and in reduced cost.

### SUMMARY OF THE INVENTION

It is an object of the present invention to provide a biodegradable chemical which could provide at least acceptable anti-greying performance and/or primary detergency for detergents, particularly for laundry detergents, and may be manufactured with more cost-effective process.

It has been found that the object of the present invention can be achieved by a lysine-based polymer wherein at least a portion of free amino groups contained in the polymer have been modified via Michael addition with an unsaturated carboxylic acid or an unsaturated carboxylic acid ester.

In one aspect, the present invention relates to a modified lysine-based polymer obtainable or obtained from a process including Michael addition of at least a portion of free amino groups in a lysine-based polymer with a Michael acceptor selected from unsaturated carboxylic acids and unsaturated carboxylic acid esters.

In another aspect, the present invention relates to a detergent composition, which comprises the modified lysine-based polymer as described in the first one aspect.

In yet another aspect, the present invention relates to use of the modified lysine-based polymer as described in the first one aspect in a detergent composition.

In a further aspect, the present invention relates to use of the modified lysine-based polymer as described in the first one aspect as a dispersing agent.

It has been found that the modified lysine-based polymer according to the present invention shows acceptable anti-greying performance and primary detergency than commercially available non-biodegradable chelating agents and dispersing agents, while having biodegradability. Additionally, the unsaturated carboxylic acids and unsaturated carboxylic acid esters as modification agents are less toxic and less corrosive than chloroacetic acid and salts thereof as used for manufacturing biodegradable carboxymethylated polylysines in WO2021228642A1.

### DETAILED DESCRIPTION OF THE INVENTION

The present invention now will be described in detail hereinafter. It is to be understood that the present invention may be embodied in many different ways and shall not be construed as limited to the embodiments set forth herein. Unless mentioned otherwise, all technical and scientific terms used herein have the same meaning as commonly understood by one of ordinary skill in the art to which the present invention belongs.

As used herein, the singular forms “a”, “an” and “the” include plural referents unless the context clearly dictates otherwise.

As used herein, the terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

As used herein, the term “biodegradable”, generally refers to a material that is able to degrade from the action of naturally occurring microorganisms, such as bacteria, fungi, and algae, environmental heat, moisture or other environmental factors.

As used herein, the term “lysine-based polymer” is intended to indicate a polymer wherein lysine accounts for a major molar proportion, i.e., more than 50 mol % of all monomers constituting the polymer, which may be a homopolymer of lysine wherein lysine accounts for 100 mol % of monomers constituting the polymer or a copolymer of lysine and one or more comonomers.

As used herein, the term “free amino groups” refers to an amino group —NH₂, which has not been undergone condensation with a carboxyl group or modification via Michael addition.

As used herein, the term “modified lysine-based polymer” is intended to refer to a lysine-based polymer containing amino groups which have been modified via Michael addition of free amino groups contained in the lysine-based polymer with an unsaturated carboxylic acid or an unsaturated carboxylic acid ester. It will be understood that the term “modified lysine-based polymer” is intended to encompass unneutralized, partially neutralized and completely neutralized forms with respect to any carboxyl groups that may be present in the polymer.

As used herein, the term “structural units” is intended to refer to the minimal molecular residue derived from a monomer after polymerization, i.e., polycondensation of the monomer. It will be understood that the term “structural unit” may also contains a moiety derived from a Michael accepter if there is a free amino group after the polycondensation of the monomer and the amino group is modified via Michael addition.

Herein, the terms “structural unit(s) from lysine monomer” and “lysine structural unit(s)” are used interchangeably. Likewise, the terms “structural units from at least one dicarboxylic acid of formula (I)” and “dicarboxylic acid structural unit(s)” are used interchangeably.

As used herein, the K-value, when mentioned for the modified lysine-based polymers according to the present invention, refers to corresponding parameters of the lysine-based polymers before modification via Michael addition, unless the context clearly dictates otherwise.

### <Modified Lysine-Based Polymer>

The modified lysine-based polymer according to the present invention may be a modified homopolymer of lysine, or a modified copolymer of a major proportion (e.g., more than 50 mol %) of lysine and a minor proportion (e.g., less than 50 mol %) of at least one other monomer.

Useful unsaturated carboxylic acids as the Michael acceptor for modifying the lysine-based polymer via Michael addition may be selected from the group consisting of α,β-ethylenically unsaturated monocarboxylic acids having 3 to 10 carbon atoms, α,β-ethylenically unsaturated dicarboxylic acids having 4 to 8 carbon atoms, α,β-ethylenically unsaturated tricarboxylic acids having 4 to 8 carbon atoms, and α,β-ethylenically unsaturated carboxylic acids having more carboxylic acid groups.

Preferably, the unsaturated carboxylic acids may be selected from the group consisting of acrylic acid, methacrylic acid, maleic acid, fumaric acid, crotonic acid, itaconic acid, citraconic acid, mesaconic acid, glutaconic acid and aconitic acid.

More preferably, the unsaturated carboxylic acids may be selected from the group consisting of acrylic acid, maleic acid and itaconic acid, among which acrylic acid may be particularly mentioned.

Useful unsaturated carboxylic acid esters as the Michael acceptor for modifying the lysine-based polymer via Michael addition may be selected from any esters of the unsaturated carboxylic acids as described hereinabove. Preferably, the unsaturated carboxylic acid esters may be selected from polyalkylene oxide esters or terminated polyalkylene oxide esters of the unsaturated carboxylic acids as described hereinabove, preferably terminated polyethylene oxide esters, terminated polypropylene oxide esters or terminated polybutylene oxide esters of the unsaturated carboxylic acids as described hereinabove, or a combination thereof. More preferably, terminated polyethylene oxide esters of unsaturated carboxylic acids, for example terminated polyethylene oxide esters of acrylic acid, maleic acid or itaconic acid, particularly acrylic acid may be mentioned.

In the terminated polyalkylene oxide esters of the unsaturated carboxylic acids, suitable terminating group may be selected from C₁-C₄-alkyl or C₁-C₄-hydroxyalkyl, for example methyl, ethyl, propyl, isopropyl, butyl, hydroxymethyl, hydroxyethyl, hydroxypropyl or hydroxybutyl.

Examples of the terminated polyalkylene oxide esters of unsaturated carboxylic acids may include, but are not limited to, polyethylene oxide mono(C₁-C₄-alkyl) ether acrylate, polyethylene oxide mono(C₁-C₄-alkyl) ether maleate, polyethylene oxide mono(C₁-C₄-alkyl) ether itaconate, preferably polyethylene oxide monomethyl ether acrylate, polyethylene oxide monomethyl ether maleate, polyethylene oxide monomethyl ether itaconate, more preferably polyethylene oxide monomethyl ether acrylate.

The moieties of polyalkylene oxide in the polyalkylene oxide esters or terminated polyalkylene oxide esters of the unsaturated carboxylic acids may have a number average molecular weight of 100 to 2,000, preferably 200 to 1,200, more preferably 400 to 800.

The unsaturated carboxylic acids and the unsaturated carboxylic acid esters useful for modifying the lysine-based polymer in the present invention are also generally be referred to as Michael acceptor herein.

As homopolymers of lysine (also referred to as lysine homopolymers) to be modified, both linear polylysines and branched polylysines are useful. It is known that polylysines may have linear or branched structures depending on the production process. For example, ε-linear polylysines are generally prepared by a microbial fermentation process as well known in the art. Branched polylysines are generally resulted from thermal polycondensation of lysine due to the fact that lysine has one reactive carboxyl group and two reactive amino groups (α-NH₂ and ε-NH₂) per molecule. For the purpose of the present invention, the type of polylysine structures (linear or branched), the arrangement of those structural units, and the degree of branching are all not critical.

In some embodiments of the present invention, the modified lysine-based polymer may be a linear or branched lysine homopolymer which has been modified with a Michael acceptor as described hereinabove. Particularly, the lysine homopolymer may be &-linear polylysines or branched polylysines.

As copolymers of lysine (also referred to as lysine copolymers) to be modified, polymerization products of more than 50 mol % of lysine with a dicarboxylic acid or an amide-forming derivative thereof are useful. Accordingly, the copolymer of lysine will contain amide moieties resulted from lysine and the dicarboxylic acid or amide-forming derivative thereof. The copolymers of lysine may be prepared by thermal polycondensation of lysine and the dicarboxylic acid or any suitable polymerization reactions of lysine and amide-forming derivative of the dicarboxylic acid.

In some other embodiments of the present invention, the modified lysine-based polymer may be a copolymer of lysine which has been modified with a Michael acceptor as described hereinabove, wherein the copolymer of lysine comprises more than 50 mol % of structural units from lysine monomer and less than 50 mol % of structural units from at least one dicarboxylic acid or amide-forming derivative thereof.

Particularly, the copolymer of lysine may be a polymer comprising
(A) 60 to 99 mol % of structural units from lysine monomer,
(B) 1 to 40 mol % of structural units from at least one dicarboxylic acid of formula (I) or amide-forming derivative thereof

HOOC—R₁—COOH (I)

wherein

R₁ is a direct bond or an aliphatic linear hydrocarbylene, which is unsubstituted or substituted with at least one group selected from unsubstituted or substituted alkyl, unsubstituted or substituted alkoxy, unsubstituted or substituted alkylthio, unsubstituted or substituted alkylamino, di(alkyl) amino, alkylidene, hydroxyl, mercapto, amino and halogen.

The term “aliphatic linear hydrocarbylene” as used herein refers to a divalent radical derived from an unsaturated or saturated acyclic hydrocarbon, which may or may not be interrupted by at least one heteroatom selected from O, S and N. Typically, hydrocarbylene groups herein will have from 1 to 24 carbon atoms (C₁-C₂₄-hydrocarbylene), preferably 1 to 18 carbon atoms (C₁-C₁₈-hydrocarbylene), more preferably 1 to 12 carbon atoms (C₁-C₁₂-hydrocarbylene). Examples of aliphatic linear hydrocarbylene groups are especially alkylene and alkenylene.

The term “alkylene” as used herein refers to a saturated divalent radical derived from straight-chain alkane, which may or may not be interrupted by at least one heteroatom selected from O, S and N. Typically, alkylene groups herein will have from 1 to 24 carbon atoms (C₁-C₂₄-alkylene), preferably 1 to 18 carbon atoms (C₁-C₁₈-alkylene), more preferably 1 to 12 carbon atoms (C₁-C₁₂-alkylene), for example C₁-C₄-alkylene and C₁-C₂-alkylene. Examples of alkylene groups are especially methylene, ethylene, trimethylene, tetramethylene, pentamethylene, hexamethylene, heptamethylene, octamethylene, nonamethylene, decamethylene, undecamethylene, dodeca-methylene, hexadecamethylene, octadecamethylene, etc.

The term “alkenylene” as used herein refers to an unsaturated divalent radical derived from straight-chain alkene where any double bond is at internal position. Typically, alkenylene groups herein will have from 2 to 24 carbon atoms (C₂-C₂₄-alkenylene), preferably 2 to 18 carbon atoms (C₂-C₁₈-alkyenlene), more preferably 2 to 12 carbon atoms (C₂-C₁₂-alkenylene). Examples of alkenylene groups are especially vinylene, 1,3-propenylene, 1,4-buta-2-enylene, 1,5-pent-2-enylene, 1,6-hex-3-enylene, etc.

The term “alkyl” as used herein and in the alkyl moieties of alkoxy, alkylthio, alkylamino, dialkylamino and the like refers to saturated straight-chain or branched hydrocarbyl having usually 1 to 18 carbon atoms (C₁-C₁₈-alkyl), preferably 1 to 12 carbon atoms (C₁-C₁₂-alkyl), more preferably 1 to 8 carbon atoms (C₁-C₈-alkyl) or 1 to 6 carbon atoms (C₁-C₆-alkyl), for example C₁-C₄-alkyl and C₁-C₂-alkyl. Examples of alkyl groups are especially methyl, ethyl, n-propyl, isopropyl, n-butyl, isobutyl, sec-butyl, tert-butyl, n-pentyl, 1-methylbutyl, 1-ethylpropyl, neo-pentyl, n-hexyl, 1-methylpentyl, 2-methylpentyl, 1-ethylbutyl, 2-ethylbutyl, n-heptyl, 1-methylhexyl, 2-methylhexyl, 1-ethylpentyl, 1-propylbutyl, 2-ethylpentyl, n-octyl, 1-methylheptyl, 2-methylheptyl, 1-ethylhexyl, 2-ethylhexyl, 1-propylpentyl, 2-propylpentyl, n-nonyl, etc.

The term “alkoxy” as used herein refers to an alkyl that is attached via an oxygen atom, which may be represented by —O-alkyl, where alkyl is as defined above.

The term “alkylthio” as used herein refers to an alkyl that is attached via a sulfur atom, which may be represented by —S-alkyl, where alkyl is as defined above.

The term “alkylamino” and “di(alkyl) amino” as used herein refer to an amino (—NH₂) with the hydrogen atoms being replaced with one or two alkyl groups respectively, where alkyl is as defined above.

The term “alkylidene” as used herein refers to unsaturated divalent radical derived from alkane with both valencies on the same carbon atom, which may be represented by *═CRₐR_{b} where the asterisk (*) denotes the position where the alkylidene group is attached to the remainder, and Ra and R_{b} respectively donates H or alkyl. Typically, alkylidene groups herein will have from 1 to 6 carbon atoms (C₁-C₆-alkylidene), preferably 1 to 4 carbon atoms (C₁-C₄-alkylidene). Examples of alkylidene groups are especially methylidene, ethylidene, propylidene, etc.

The term “halogen” as used herein refers to fluorine, bromine, chlorine and iodine.

In a particular embodiment, the modified lysine-based polymer according to the present invention comprises the structural units from lysine monomer represented by for example,

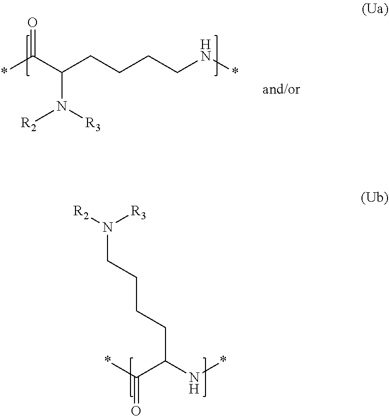

wherein
R₂ and R₃ independently from each other is H or R₄, provided that at least one of R₂ and R₃ is R₄,
R₄ denotes a moiety derived from the Michael acceptor via Michael addition, and
* denotes the position where the structural unit is attached to any other structural units by an amide linkage.

In some embodiments, the modified lysine-based polymer according to the present invention comprises at least one of structural units (Ua) and structural units (Ub) as described hereinabove, wherein R⁴ in (Ua) and (Ub) denotes a moiety represented by formula (II)

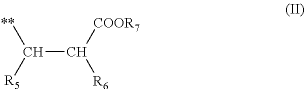

in which
R₅ and R₆ independently from each other are H, C₁-C₆-alkyl, carboxyl (—COOH), —COOM, —(C₁-C₄-alkylene)-COOH or —(C₁-C₄-alkylene)-COOM,
R₇ is H, C₁-C₆-alkyl, —(CH₂CH₂O)ₙ—R₈ or M,
R₈ is C₁-C₄-alkyl,
M is a cation selected from alkali metal cations, alkaline earth metal cations, ammonium and amine cations,
n is a number in the range of 2 to 40, and
** donates the position where the moiety is attached to the N atom carrying R₄.

Preferably, the modified lysine-based polymer according to the present invention comprises structural units (Ua) and/or structural units (Ub) wherein R⁴ denotes a moiety represented by formula (II) in which
R₅ and R₆ independently from each other are H, C₁-C₄-alkyl, carboxyl (—COOH), —COOM, —(C₁-C₂-alkylene)-COOH or —(C₁-C₂-alkylene)-COOM,
R₇ is H, —(CH₂CH₂O)ₙ—R₈ or M,
R₈ is C₁-C₂-alkyl,
M is a cation selected from alkali metal cations, alkaline earth metal cations, ammonium and amine cations,
n is a number in the range of 4 to 25, and
** donates the position where the moiety is attached to the N atom carrying R₄.

More preferably, the modified lysine-based polymer according to the present invention comprises structural units (Ua) and/or structural units (Ub) wherein R⁴ denotes a moiety represented by formula (II) in which
R₅ is H, methyl, carboxyl (—COOH), or —COOM,
R₆ is H, methyl, carboxyl (—COOH), —COOM, —(C₁-C₂-alkylene)-COOH or —(C₁-C₂-alkylene)-COOM,
R₇ is H, —(CH₂CH₂O)ₙ—R₈ or M,
R₈ is C₁-C₂-alkyl,
M is a cation selected from alkali metal cations, alkaline earth metal cations, ammonium and amine cations,
n is a number in the range of 8 to 15, and
** donates the position where the moiety is attached to the N atom carrying R₄.

Most preferably, the modified lysine-based polymer according to the present invention comprises structural units (Ua) and/or structural units (Ub) wherein R⁴ denotes a moiety represented by formula (II) in which
R₅ is H, carboxyl (—COOH), or —COOM,
R₆ is H, carboxyl (—COOH), —COOM, —(C₁-C₂-alkylene)-COOH or —(C₁-C₂-alkylene)-COOM,
R₇ is H, —(CH₂CH₂O)ₙ—R₈ or M,
R₈ is methyl,
M is a cation selected from alkali metal cations, alkaline earth metal cations, ammonium and amine cations,
n is a number in the range of 8 to 15, and
** donates the position where the moiety is attached to the N atom carrying R₄.

Particularly, the modified lysine-based polymer according to the present invention comprises structural units (Ua) and/or structural units (Ub) wherein R⁴ denotes a moiety represented by

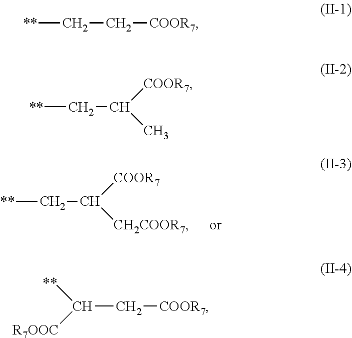

in which,
R₇ is H, —(CH₂CH₂O)ₙ—R₈ or M,
R₈ is methyl,
M is a cation selected from alkali metal cations, alkaline earth metal cations, ammonium and amine cations,
n is a number in the range of 8 to 15, and
*donates the position where the moiety is attached to the N atom carrying R₄.

More particularly, R₇ is H, —(CH₂CH₂O)ₙ—R₈ or M in formula (II-1), and is H or M in formulae (II-2), (II-3) and (II-4), wherein R₈, M and n are as described hereinabove for formulae (II-1), (II-2), (II-3) and (II-4).

In formula (II) and each of formulae (II-1) to (II-4) as described hereinabove, M is preferably a cation selected from sodium, potassium, calcium, magnesium, ammonium or amine cation.

Each lysine structural unit as described above may be linked to same or different lysine structural units to form amide linkages like *-Ua-Ua-*, *-Ua-Ub-*, *-Ub-Ub-*, and any other possible linkages. It will be appreciated that the modified lysine-based polymer may comprise more than one type of above amide linkages. The lysine structural unit as described above may also be linked to a dicarboxylic acid structural unit in case of a copolymer of lysine as described in the present invention.

The modified lysine-based polymer according to the present invention may comprise dicarboxylic acid structural units represented by for example formula (III),

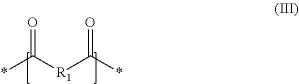

wherein
R₁ is as defined herein above for the formula (I),
* denotes the position where the structural unit is attached to any other structural units by an amide linkage.

It will be understood that each structural unit of formula (III) as described above may be linked to two lysine structural units of the same or different linkages.

It will also be understood that the dicarboxylic acid structural units comprised in the carboxyalkyl modified lysine-based polymer according to the present invention may also be in any other possible form when R₁ is a hydrocarbylene substituted with an amino group (NH₂). The amino substitute is reactive to the carboxyl groups contained in the lysine monomer and dicarboxylic acid and may form corresponding amide linkage.

In a particular embodiment, the modified lysine-based polymer according to the present invention comprises (B) structural units from at least one dicarboxylic acid of formula (I) or amide-forming derivative thereof wherein R₁ is a direct bond or an aliphatic linear C₁-C₂₄-hydrocarbylene, which is unsubstituted or substituted with at least one group selected from unsubstituted or substituted C₁-C₁₈-alkyl, unsubstituted or substituted C₁-C₁₈-alkoxy, unsubstituted or substituted C₁-C₁₈-alkylthio, unsubstituted or substituted C₁-C₁₈-alkylamino, di(C₁-C₁₈-alkyl)amino, C₁-C₆-alkylidene, hydroxyl, mercapto, amino and halogen.

In a preferable embodiment, the modified lysine-based polymer according to the present invention comprises (B) structural unitsfrom at least one dicarboxylic acid of formula (I) or amide-forming derivative thereof wherein R₁ is a direct bond or an aliphatic linear C₁-C₁₈-hydrocarbylene, which is unsubstituted or substituted with at least one group selected from unsubstituted or substituted C₁-C₁₂-alkyl, unsubstituted or substituted C₁-C₁₂-alkoxy, unsubstituted or substituted C₁-C₁₂-alkylthio, unsubstituted or substituted C₁-C₁₂-alkylamino, di(C₁-C₁₂-alkyl)amino, C₁-C₄-alkylidene, hydroxyl, mercapto, amino and halogen.

In a more preferable embodiment, the modified lysine-based polymer according to the present invention comprises (B) structural units from at least one dicarboxylic acid of formula (I) or amide-forming derivative thereof wherein R₁ is a direct bond or an aliphatic linear C₁-C₁₂-hydrocarbylene, which is unsubstituted or substituted with at least one group selected from unsubstituted or substituted C₁-C₈-alkyl, unsubstituted or substituted C₁-C₈-alkoxy, unsubstituted or substituted C₁-C₈-alkylthio, unsubstituted or substituted C₁-C₈-alkylamino, di(C₁-C₈-alkyl)amino, C₁-C₄-alkylidene, hydroxyl, mercapto, amino and halogen.

In a further preferable embodiment, the modified lysine-based polymer according to the present invention comprises (B) structural units from at least one dicarboxylic acid of formula (I) or amide-forming derivative thereof wherein R₁ is a direct bond, C₁-C₁₂-alkylene or C₂-C₁₂-alkenylene, which are unsubstituted or substituted with at least one group selected from unsubstituted or substituted C₁-C₄-alkyl, unsubstituted or substituted C₁-C₄-alkoxy, unsubstituted or substituted C₁-C₄-alkylthio, unsubstituted or substituted C₁-C₄-alkylamino, di(C₁-C₄-alkyl)amino, C₁-C₄-alkylidene, hydroxyl, mercapto, amino and halogen.

In a still preferable embodiment, the modified lysine-based polymer according to the present invention comprises (B) structural units from at least one dicarboxylic acid of formula (I) or amide-forming derivative thereof wherein R₁ is a direct bond, C₁-C₁₂-alkylene or C₂-C₁₂-alkenylene, which are unsubstituted or substituted with at least one group selected from unsubstituted or substituted C₁-C₄-alkyl, C₁-C₄-alkylidene, hydroxyl, mercapto and amino.

In a most preferable embodiment, the modified lysine-based polymer according to the present invention comprises (B) structural units from at least one dicarboxylic acid of formula (I) or amide-forming derivative thereof wherein R₁ is a direct bond, C₁-C₁₂-alkylene or C₂-C₁₂-alkenylene, which are unsubstituted or substituted with at least one group selected from unsubstituted or substituted C₁-C₄-alkyl, C₁-C₂-alkylidene, hydroxyl and amino.

Particularly, the modified lysine-based polymer according to the present invention comprises (B) structural units from at least one of oxalic acid, malonic acid, succinic acid, maleic acid, fumaric acid, tartaric acid, aspartic acid, glutaric acid, itaconic acid, glutamic acid, adipic acid, pimelic acid, suberic acid, azelaic acid, sebacic acid, undecanedioic acid and dodecanedioic acid, more preferably at least one of succinic acid, tartaric acid, glutaric acid, adipic acid, most preferably tartaric acid or adipic acid.

Preferably, the modified lysine-based polymer according to the present invention comprises
(A) 70 to 97 mol % of the lysine structural units; and
(B) 3 to 30 mol % of the dicarboxylic acid structural units.

More preferably, the modified lysine-based polymer according to the present invention comprises;
(A) 75 to 97 mol % of the lysine structural units; and
(B) 4 to 25 mol % of the dicarboxylic acid structural units.

Most preferably, the modified lysine-based polymer according to the present invention comprises
(A) 75 to 95 mol % of the lysine structural units; and
(B) 5 to 25 mol % of the dicarboxylic acid structural units.

The carboxymethylated lysine-based polymer according to the present invention may be prepared from a lysine-based polymer having a K-value in the range of 8 to 20, more preferably 9 to 15, and most preferably 9.5 to 13, as determined with 1 wt % solution of respective lysine-based polymer in water at 23° C. according to DIN ISO 1628-1. The K-value is often referred to as intrinsic viscosity and is an indirect measure of molecular weight of polymers.

The modified lysine-based polymer according to the present invention has a degree of modification (DM) via Michael addition of at least 10%, for example 20%, 30%, 35%, 40%, 45%, 50%, 60%, 65%, 70%, 80% or higher. For example, the DM may be in ranges of 10 to 70%, preferably 20 to 50%.

Herein, the degree of modification (DM) is defined theoretically in accordance with the following equation:

$$DM = \frac{\begin{matrix}moles of the moieties derived from the \\ Michael acceptor after Michael addition\end{matrix}}{\begin{matrix}2 \times ( moles of structural units of lysine + moles of \\ dicarboxylic acid structural units having an amino when present )\end{matrix}} \times 100 \%$$

Measurement of DM may be carried out by hydrolyzing the modified lysine-based polymer and determining the moles of moieties derived from the Michael acceptor after Michael addition, the moles of structural units of lysine, and the moles of dicarboxylic acid structural units having an amino group when present according to the resonance signals assigned to respective protons in the hydrolysis products as measured by ¹H NMR in D₂O. It will be understood that the measured DM value may not be exactly the same as the theoretical value due to the limitation of the measurement method.

The modified lysine-based polymer according to the present invention has a weight average molecular weight (Mw) in the range of 600 to 20,000 g/mol, preferably 700 to 17,000 g/mol, more preferably 800 to 13,000 g/mol, and/or has a number average molecular weight (Mn) in the range of 500 to 20,000 g/mol, preferably 600 to 15,000 g/mol, more preferably 700 to 12,000 g/mol. The average molecular weights may be determined in accordance with the methods described herein below.

There is no particular restriction to the process for preparing the modified lysine-based polymer according to the present invention. Generally, the modified lysine-based polymer according to the present invention may be prepared by a process including reacting a lysine-based polymer with a Michael acceptor as described hereinabove under a condition controlled for Michael addition between free amino groups and the unsaturated carboxylic acids or unsaturated carboxylic acid esters as the Michael acceptor. It can be contemplated that the modified lysine-based polymer may also be prepared by a process including reacting a lysine-based polymer with an unsaturated carboxylic acid as the Michael acceptor and optionally esterification. Known conditions for Michael addition between free amino groups and the unsaturated carboxylic acids or unsaturated carboxylic acid esters may be applied without restrictions.

It has been found that the modified lysine-based polymers according to the present invention are useful as a dispersing and/or chelating agent in detergent compositions.

### <Detergent Compositions>

According to the present invention, the detergent composition may be any compositions comprising a surfactant or a surfactant mixture to provide cleansing efficacy. Particularly, the detergent composition is a laundry detergent composition.

There is no restriction to the formulation of the detergent composition. The modified lysine-based polymer according to the present invention are useful for any conventional formulations of detergent composition such as laundry detergent composition. It is to be understood that the modified lysine-based polymer according to the present invention may be used in the detergent compositions in addition to or in place of the dispersing agent and/or chelating agent which would otherwise be comprised in a conventional formulation of the detergent composition.

In some embodiments of the present invention, the laundry detergent composition comprises the modified lysine-based polymer according to the present invention in an amount of 0.5 to 30%, preferably 1 to 25%, and more preferably 1 to 15% by weight, for example 1 to 10% by weight based on the total solid content of the detergent composition.

As the essential component providing the cleansing efficacy for the detergent composition, at least one of cationic, anionic, nonionic and amphoteric surfactants may be comprised depending on the specific applications and desired performances of the detergent composition.

### Nonionic Surfactants

Useful nonionic surfactants may include, but are not limited to condensation products of (1) alcohols with ethylene oxide, of (2) alcohols with ethylene oxide and a further alkylene oxide, of (3) polypropylene glycol with ethylene oxide or of (4) ethylene oxide with a reaction product of ethylenediamine and propylene oxide, fatty acid amides, and semipolar nonionic surfactants.

Condensation product of alcohols with ethylene oxide derives for example from alcohols having a C₈ to C₂₂-alkyl group, preferably a C₁₀ to C₁₈-alkyl group, which may be linear or branched, primary or secondary. The alcohols are condensed with about 1 to 25 mol and preferably with about 3 to 18 moles of ethylene oxide per mole of alcohol.

Condensation products of alcohols with ethylene oxide and a further alkylene oxide may be constructed according to the scheme R-O-EO-AO or R-O-AO-EO, where R is a primary or secondary, branched or linear C₈ to C₂₂-alkyl group, preferably a C₁₀ to C₁₈-alkyl group, EO is ethylene oxide and AO comprises an alkylene oxide, preferably propylene oxide, butylene oxide or pentylene oxide.

Condensation products of polypropylene glycol with ethylene oxide comprise a hydrophobic moiety preferably having a molecular weight of from about 1,500 to about 1,800. The addition of up to about 40 moles of ethylene oxide onto this hydrophobic moiety leads to amphiphilic compounds.

Condensation products of ethylene oxide with a reaction product of ethylenediamine and propylene oxide comprises a hydrophobic moiety consisting of the reaction product of ethylenediamine and propylene oxide and generally having a molecular weight of from about 2,500 to about 3,000. Ethylene oxide is added up to a content, based on the hydrophobic unit, of about 40% to about 80% by weight of polyoxyethylene and a molecular weight of from about 5,000 to about 11,000.

Fatty acid amides may be those of following formula

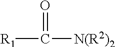

where
R¹ is an alkyl radical having 7 to 21 and preferably 9 to 17 carbon atoms, and
R², independently from each other, is hydrogen, C₁ to C₄-alkyl, C₁ to C₄-hydroxyalkyl or (C₂H₄O)ₓH
where x varies from 1 to 3.

Preference is given to C₈ to C₂₀-fatty acid amides such as monoethanolamides, diethanolamides and diisopropanolamides.

As the semipolar nonionic surfactants, water-soluble amine oxides, water-soluble phosphine oxides and water-soluble sulfoxides each having at least one C₈ to C₁₈-alkyl group, preferably C₁₀ to C₁₄-alkyl group may be mentioned. Preference is given to C₁₀-C₁₂-alkoxyethyldihydroxyethylamine oxides.

### Anionic Surfactants

Useful anionic surfactants may include but are not limited to alkenyl- or alkyl benzenesulfonates, alkanesulfonates, olefinsulfonates, alkyl ester sulfonates, alkyl sulfates, alkyl ether sulfates, alkyl carboxylates (soap). The counter-ions present are alkali metal cations, preferably sodium or potassium, alkaline earth metal cations, for example calcium or magnesium, and also ammonium and substituted ammonium compounds, such as mono-, di- or triethanol ammonium cations and mixtures of the aforementioned cations therefrom.

Alkenyl- or alkyl benzenesulfonates may comprise a branched or linear, optionally hydroxyl-substituted alkenyl or alkyl group, preferably linear C₉ to C₂₅-alkyl group.

Alkane sulfonates are available on a large industrial scale in the form of secondary alkanesulfonates where the sulfo group is attached to a secondary carbon atom of the alkyl moiety. The alkyl can in principle be saturated, unsaturated, branched or linear and optionally hydroxyl substituted. Preferred secondary alkane sulfonates comprise linear C₉ to C₂₅-alkyl radicals, preferably C₁₀ to C₂₀-alkyl radicals and more preferably C₁₂ to C₁₈-alkyl radicals.

Olefinsulfonates are obtained by sulfonation of C₈ to C₂₄ and preferably C₁₄ to C₁₆-α-olefins with sulfur trioxide and subsequent neutralization. Owing to their production process, these olefinsulfonates may comprise minor amounts of hydroxy alkanesulfonates and alkanedisulfonates.

Alkyl ester sulfonates derive for example from linear ester of C₈ to C₂₀-carboxylic acids, i.e., fatty acids, which are sulfonated with sulfur trioxide. Compounds of following formula are preferred

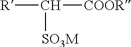

where
R′ is a C₈ to C₂₀-alkyl radical, preferably C₁₀ to C₁₆-alkyl and R″ is a C₁ to Co-alkyl radical, preferably a methyl, ethyl or isopropyl group. Particular preference is given to methyl ester sulfonates where R¹ is C₁₀ to C₁₆-alkyl.

Alkyl sulfates are surfactants of the formula ROSO₃M′, where R is C₁₀ to C₂₄-alkyl and preferably C₁₂ to C₁₈-alkyl. M′ is a counter-ion as described at the beginning for anionic surfactants.

Alkyl ether sulfates have the general structure RO(A)ₘSO₃M, where R is a C₁₀ to C₂₄-alkyl and preferably C₁₂ to C₁₈-alkyl radical, where A is an alkoxy unit, preferably ethoxy and m is a value from about 0.5 to about 6, preferably between about 1 and about 3, and M is a cation, for example sodium, potassium, calcium, magnesium, ammonium or a substituted ammonium cation.

Alkyl carboxylates are generally known by the term “soap”. Soap can be manufactured on the basis of saturated or unsaturated, preferably natural, linear C₈ to C₁₈-fatty acid. Saturated fatty acid soaps include for example the salts of lauric acid, myristic acid, palmitic acid, stearic acid, hydrogenated erucic acid and behenic acid, and in particular soap mixtures derived from natural fatty acids, for example coconut, palm kernel or tallow fatty acids. Known alkenylsuccinic acid salts may also be used together with soap or as substitutes for soap.

Further anionic surfactant are salts of acylamino carboxylic acids, acyl sarcosinates, fatty acid-protein condensation products obtained by reaction of fatty acid chlorides with oligopeptides; salts of alkylsulfamido carboxylic acids; salts of alkyl and alkylary ether carboxylic acids; sulfonated polycarboxylic acids, alkyl and alkenyl glycerol sulfates, such as oleyl glycerol sulfates, alkylphenol ether sulfates, alkyl phosphates, alkyl ether phosphates, isethionates, such as acyl isethionates, N-acyltaurides, alkyl succinates, sulfosuccinates, monoesters of sulfosuccinates (particularly saturated and unsaturated C₁₂ to C₁₈-monoesters) and diesters of sulfosuccinates (particularly saturated and unsaturated C₁₂ to C₁₈-diesters), sulfates of alkylpolysaccharides such as sulfates of alkylpolyglycosides and alkypolysaccharides such as sulfates of alkylpolyglycosides and alkyl polyethoxy carboxylates such as those of the formula RO(CH₂CH₂)ₖCH₂COOM, where R is C₈ to C₂₂-alkyl, k is a number from 0 to 10 and M is a cation.

### Cationic Surfactants

Useful cationic surfactants may be substituted or unsubstituted straight chain or branched quaternary ammonium salts of R¹N(CH₃)₃⁺X⁻, R¹R²N(CH₃)₂⁺X⁻, R¹R²R³N(CH₃)⁺X⁻ or R¹R²R³R⁴N⁺X⁻, where R¹, R², R³ and R⁴ independently from each other are unsubstituted C₈ to C₂₄-alkyl and preferably C₈ to C₁₈-alkyl, hydroxylalkyl having 1 to 4 carbon atoms, phenyl, C₂ to C₁₈-alkenyl, C₇ to C₂₄-aralkyl, (C₂H₄O)ₓH where x is from about 1 to about 3, the alkyl radical optionally comprising one or more ester groups, and X is a suitable anion. Useful cationic surfactants may also be cyclic quaternary ammonium salts.

### Amphoteric/Zwitterionic Surfactants

Useful amphoteric surfactants may be aliphatic derivatives of secondary or tertiary amines, or aliphatic derivatives of heterocyclic secondary and tertiary amines, in which the aliphatic radical may be straight or branched-chain and where one of the aliphatic substituents contains at least about 8 carbon atoms, or from about 8 to about 18 carbon atoms, and at least one of the aliphatic substituents contains an anionic water-solubilizing group, e.g. carboxy, sulfonate, sulfate. Suitable amphoteric surfactants also include sarcosinates, glycinates, taurinates, and mixtures thereof. Examples of the species as the amphoteric surfactants are known in the art, for example from WO2005095569A1.

Useful zwitterionic surfactants may be derivatives of secondary and tertiary amines, derivatives of heterocyclic secondary and tertiary amines, or derivatives of quaternary ammonium, quaternary phosphonium or tertiary sulfonium compounds. Suitable Examples of zwitterionic surfactants include, but are not limited to, betaines such as alkylbetaines and alkylamide betaines, such as N-alkyl-N,N-dimethyl-N-carboxymethylbetaines, N-(alkylamidopropyl)-N,N-dimethyl-N-carboxymethylbetaines, alkyldipolyethoxybetains, alkylamine oxides, and sulfo and hydroxy betaines such as N-alkyl-N,N-dimethylammino-1-propane sulfonate, each having a linear or branched C₈ to C₂₂-alkyl, preferably C₈ to C₁₈-alkyl radical and more preferably C₁₂ to C₁₈-alkyl.

In an exemplary embodiment of the present invention, a laundry detergent composition may comprise 0.1 to 80% by weight of at least one surfactant selected from anionic surfactants, amphoteric surfactants and nonionic surfactants, based on the total solid content of the detergent composition. Some preferred laundry detergent composition of the present invention may contain at least one anionic or non-ionic surfactant.

### Auxiliaries

The detergent composition may further comprise customary auxiliaries which serve to modify the performance characteristics of the detergent composition.

Suitable auxiliaries for detergent compositions may include but are not limited to builder such as complexing agent other than modified lysine-based polymer according to the present invention, ion exchange agent and precipitating agent, bleaching agent, bleach activators, corrosion inhibitor, foam boosters, antifoams, dyes, fillers, color care agent, optical brightener, disinfectant, alkalis, antioxidant, thickener, perfume, solvent, solubilizer, softener and antistatic agent. By way of example, some auxiliaries will be described hereinbelow.

Generally, the detergent composition may comprise at least one builder selected from organic and inorganic builders. Examples of suitable inorganic builders are sodium sulfate or sodium carbonate or silicates, in particular sodium disilicate and sodium metasilicate, zeolites, sheet silicates, in particular those of the formula α-Na₂Si₂O₅, β-Na₂Si₂O₅, and δ-Na₂Si₂O₅. Examples of suitable organic builders are fatty acid sulfonates, α-hydroxypropionic acid, alkali metal malonates, fatty acid sulfonates, alkyl and alkenyl disuccinates, tartaric acid diacetate, tartaric acid monoacetate, oxidized starch, methylglycinediacetic acid and its alkali salts, especially Na-salts, N,N-dicarboxymethyl glutamic acid and its alkali salts, especially Na-salts, citric acid and its Na-salts, and polymeric builders, for example polycarboxylates and polyaspartic acid.

The detergent composition may comprise the builder, for example, in a total amount of 10 to 70% by weight, preferably up to 50% by weight, based on the total solid content of the detergent composition. In the context of the present invention, the modified lysine-based polymer according to the present invention are not counted as the builder.

The detergent composition may comprise at least one antifoam, selected for example from silicone oils and paraffin oils. The antifoams may be in a total amount of 0.05 to 0.5% by weight, based on the total solid content of the detergent composition.

The detergent composition may comprise at least one bleaching agent. The bleaching agent may be selected from chlorine bleach and peroxide bleach.

Peroxide bleach may be selected from inorganic peroxide bleach and organic peroxide bleach. Preferred inorganic peroxide bleaches are selected from alkali metal percarbonate, alkali metal perborate and alkali metal persulfate. In solid detergent compositions for hard surface cleaning and in solid laundry detergent compositions, alkali metal percarbonates, especially sodium percarbonates, are preferably used in coated form. Such coatings may be of organic or inorganic nature. Examples are glycerol, sodium sulfate, silicate, sodium carbonate, and any combinations thereof, for example combinations of sodium carbonate and sodium sulfate. Examples of organic peroxide bleaching agents are percarboxylic acids.

Suitable chlorine-containing bleaches are, for example, 1,3-dichloro-5,5-dimethylhydantoin, N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate. The laundry detergent composition may comprise the chlorine-containing bleach, for example, in a total amount of from 3 to 10% by weight, based on the total solid content of the detergent composition.

The detergent composition may also comprise at least one bleach activator for example N-methylmorpholinium-acetonitrile salts (“MMA salts”), tri-methylammonium acetonitrile salts, N-acylimides such as N-nonanoylsuccinimide, 1,5-diacetyl-2,2-dioxohexahydro-1,3,5-triazine (“DADHT”) or nitrile quats (trimethylammonium acetonitrile salts). Further examples of bleach activators are tetraacetylethylenediamine (TAED) and tetraacetylhexylenediamine.

The detergent composition may comprise at least one corrosion inhibitor. Examples of suitable corrosion inhibitors are triazoles, in particular benzotriazoles, bisbenzotriazoles, aminotriazoles, alkylaminotriazoles, phenol derivatives as such hydroquinone, pyrocatechol, hydroxyhydroquinone, gallic acid, phloroglucinol or pyrogallol. The detergent composition may comprise the corrosion inhibitor in a total amount of 0.1 to 1.5% by weight, based on the total solid content of the detergent composition.

The detergent composition according to the present invention comprises additionally at least one enzyme. Preferably, the at least one enzyme is a detergent enzyme.

Suitable enzymes may be classified as oxidoreductase (EC 1), transferase (EC 2), hydrolase (EC 3), lyase (EC 4), isomerase (EC 5), or ligase (EC 6) (the EC-numbering is according to Enzyme Nomenclature, Recommendations (1992) of the Nomenclature Committee of the International Union of Biochemistry and Molecular Biology including its supplements published 1993-1999). Preferably, the enzyme is a hydrolase (EC 3).

Preferably, the enzyme is selected from the group consisting of proteases, amylases, lipases, cellulases, mannanases, hemicellulases, phospholipases, esterases, pectinases, lactases, peroxidases, xylanases, cutinases, pectate lyases, keratinases, reductases, oxidases, phenoloxidases, lipoxygenases, ligninases, pullulanases, tannases, pentosanases, malanases, beta-glucanases, arabinosidases, hyaluronidases, chondroitinases, laccases, nucleases, DNase, phosphodiesterases, phytases, carbohydrases, galactanases, xanthanases, xyloglucanases, oxidoreductase, perhydrolases, aminopeptidase, asparaginase, carbohydrase, carboxypeptidase, catalase, chitinase, cyclodextrin glycosyltransferase, alpha-galactosidase, beta-galactosidase, glucoamylase, alpha-glucosidase, beta-glucosidase, invertase, ribonuclease, transglutaminase, and dispersins, and any combinations thereof. More preferably, the enzyme is selected from the group consisting of proteases, amylases, lipases, cellulases, mannanases, xylanases, DNases, dispersins, pectinases, oxidoreductases, and cutinases, and any combinations thereof. Particularly, the enzyme is a protease, preferably a serine protease, more preferably a subtilisin protease.

Such enzyme(s) may be incorporated into the composition at a level sufficient to provide an effective amount for achieving a beneficial effect, preferably for primary washing effect and/or secondary washing effect, like anti-greying or anti-pilling effect (e.g., in case of cellulases). Preferably, the enzyme is present in the composition at an amount of 0.00001% to 5%, preferably 0.00001% to 2%, more preferably 0.0001% to 1%, or even more preferably 0.001% to 0.5% enzyme protein by weight of the composition.

Preferably, the detergent composition according to the present invention may further comprise an enzyme stabilizing system. Preferably, the composition according to the present invention comprises the enzyme stabilizing system in an amount of 0.001 to 10%, 0.005 to 8%, or 0.01 to 6%, based on the total weight of the composition. The enzyme stabilizing system may be any stabilizing system which is compatible with the enzyme.

Preferably, the enzyme stabilizing system comprises at least one compound selected from the group consisting of polyols such as 1,3-propanediol, ethylene glycol, glycerol, 1,2-propanediol or sorbitol), inorganic salts such as CaCl₂), MgCl2 or NaCl, short chain (preferably C₁-C₆) carboxylic acids and salts thereof such as formic acid, formate (preferably sodium formate), acetic acid, acetate or lactate), borate, boric acid, boronic acids (preferably, 4-formyl phenylboronic acid (4-FPBA)), peptide aldehydes, peptide acetals, and peptide aldehyde hydrosulfite adducts.

Preferably, the enzyme stabilizing system comprises a combination of at least two of the compounds selected from the group consisting of inorganic salts, polyols, and short chain carboxylic acids, and preferably one or more of the compounds selected from the group consisting of borate, boric acid, boronic acids (preferably, 4-formyl phenylboronic acid (4-FPBA)), peptide aldehydes, peptide acetals, and peptide aldehyde hydrosulfite adducts. In particular, if a protease is present in the composition, a protease inhibitor may be added, which is preferably selected from borate, boric acid, boronic acids (preferably, 4-FPBA), peptide aldehydes (preferably, peptide aldehydes like Z-VAL-H or Z-GAY-H), peptide acetals, and peptide aldehyde hydrosulfite adducts.

The detergent composition comprising the modified lysine-based polymer according to the present invention may also comprise at least one antimicrobial agent and/or preservative.

An antimicrobial agent is a chemical compound that kills microorganisms or inhibits their growth or reproduction. Microorganisms can be bacteria, yeasts or molds.

A preservative is an antimicrobial agent which may be added to aqueous products and compositions to maintain the original performance, characteristics and integrity of the products and compositions by killing contaminating microorganisms or inhibiting their growth. Examples of preservatives are as listed on pages 35 to 39 in patent application WO2021/115912 A1.

Especially of interest are the following antimicrobial agents and/or preservatives:
4,4′-dichloro-2-hydroxydiphenyl ether (Synonyms: 5-chloro-2-(4-chlorophenoxy) phenol, Diclosan, DCPP);
2-Phenoxyethanol (Synonyms: Phenoxyethanol, Methylphenylglycol, Phenoxetol, ethylene glycol phenyl ether, Ethylene glycol monophenyl ether, 2-(phenoxy) ethanol, 2-phenoxy-1-ethanol);
2-bromo-2-nitropropane-1,3-diol (Synonyms: 2-bromo-2-nitro-1,3-propanediol, Bronopol);
Glutaraldehyde (Synonyms: 1-5-pentandial, pentane-1,5-dial, glutaral, glutardialdehyde);
Glyoxal (Synonyms: ethandial, oxylaldehyde, 1,2-ethandial);
2-butyl-benzo[d]isothiazol-3-one (BBIT);
2-methyl-2H-isothiazol-3-one (MIT);
2-octyl-2H-isothiazol-3-one (OIT);
5-Chloro-2-methyl-2H-isothiazol-3-one (CIT or CMIT);
Mixture of 5-chloro-2-methyl-2H-isothiazol-3-one (CMIT) and 2-methyl-2H-isothiazol-3-one (MIT) (Mixture of CMIT/MIT);
1,2-benzisothiazol-3 (2H)-one (BIT);
Hexa-2,4-dienoic acid (trivial name “sorbic acid”) and its salts, e.g., calcium sorbate, sodium sorbate; potassium (E,E)-hexa-2,4-dienoate (Potassium Sorbate);
Lactic acid and its salts; L-(+)-lactic acid; especially sodium lactate;
Benzoic acid and salts of benzoic acid, e.g., sodium benzoate, ammonium benzoate, calcium benzoate, magnesium benzoate, MEA-benzoate, potassium benzoate;
Salicylic acid and its salts, e.g., calcium salicylate, magnesium salicylate, MEA salicylate, sodium salicylate, potassium salicylate, TEA salicylate;
Benzalkonium chloride, benzalkonium bromide, benzalkonium saccharinate;
Didecyldimethylammonium chloride (DDAC);
N-(3-aminopropyl)-N-dodecylpropane-1,3-diamine (Diamine);
Peracetic acid; and
Hydrogen peroxide.

The at least one antimicrobial agent or preservative may be added in the detergent composition in an amount of 0.0001 to 10%, based on the total weight of the composition.

Preferably, the detergent composition comprises 2-phenoxyethanol in an amount of 2 ppm to 5%, preferably 0.1 to 2%, or 4,4′-dichloro-2-hydroxydiphenyl ether (DCPP) in an amount of 0.001 to 3%, preferably 0.002 to 1%, more preferably 0.01 to 0.6%, based on the total weight of the composition.

Suitable species and dosages of the conventional auxiliaries for the detergent composition, particularly laundry detergent composition, are well-known in the art and may be found in for example WO 2017174413A1 and WO 2015187757A1.

### EMBODIMENTS

Various embodiments are listed below. It will be understood that the embodiments listed below may be combined with all aspects and other embodiments in accordance with the scope of the invention.

1. A modified lysine-based polymer obtainable or obtained from a process including Michael addition of at least a portion of free amino groups in a lysine-based polymer with a Michael acceptor selected from at least one of unsaturated carboxylic acids and unsaturated carboxylic acid esters.

2. The modified lysine-based polymer according to Embodiment 1, wherein the Michael acceptor is at least one selected from the group consisting of α,β-ethylenically unsaturated monocarboxylic acids having 3 to 10 carbon atoms, α,β-ethylenically unsaturated dicarboxylic acids having 4 to 8 carbon atoms, α,β-ethylenically unsaturated tricarboxylic acids having 4 to 8 carbon atoms, α,β-ethylenically unsaturated carboxylic acids having more carboxylic acid groups, and any esters thereof.

3. The modified lysine-based polymer according to Embodiment 2, wherein the Michael acceptor is at least one selected from the group consisting of acrylic acid, methacrylic acid, maleic acid, fumaric acid, crotonic acid, itaconic acid, citraconic acid, mesaconic acid, glutaconic acid, aconitic acid, and any esters thereof.

4. The modified lysine-based polymer according to Embodiment 3, wherein the Michael acceptor is at least one selected from the group consisting of acrylic acid, maleic acid, itaconic acid, and any esters thereof.

5. The modified lysine-based polymer according to any of preceding Embodiments, wherein the esters are selected from polyalkylene oxide esters or terminated polyalkylene oxide esters of the unsaturated carboxylic acids, preferably terminated polyethylene oxide esters, terminated polypropylene oxide esters or terminated polybutylene oxide esters, or a combination thereof.

6. The modified lysine-based polymer according to any of preceding Embodiments, wherein the terminated polyethylene oxide esters contain a terminating group selected from C₁-C₄-alkyl or C₁-C₄-hydroxyalkyl.

7. The modified lysine-based polymer according to Embodiment 5 or 6, wherein moieties of the polyalkylene oxide or terminated polyalkylene oxide have a number average molecular weight of 100 to 2,000, preferably 200 to 1,200 and more preferably 400 to 800.

8. A modified lysine-based polymer, which comprises the structural units from lysine monomer represented by

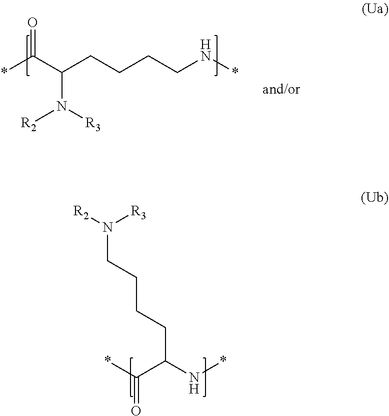

wherein
R₂ and R₃, independently from each other, is H or R₄, provided that at least one of R₂ and R₃ is R₄,
* denotes the position where the structural unit is attached to any other structural units by an amide linkage,
R₄ is a moiety represented by formula (II)

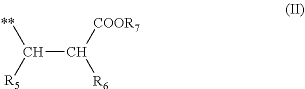

in which
R₅ and R₆ independently from each other are H, C₁-C₆-alkyl, carboxyl (—COOH), —COOM, —(C₁-C₄-alkylene)-COOH or —(C₁-C₄-alkylene)-COOM,
R₇ is H, C₁-C₆-alkyl, —(CH₂CH₂O)ₙ—R₈ or M,
R₈ is C₁-C₄-alkyl,
M is a cation selected from alkali metal cations, alkaline earth metal cations, ammonium and amine cations,
n is a number in the range of 2 to 40, and
** donates the position where the moiety is attached to the N atom carrying R₄.

9. The modified lysine-based polymer according to Embodiment 8, wherein R₅ and R₆ independently from each other are H, C₁-C₄-alkyl, carboxyl (—COOH), —COOM, —(C₁-C₂-alkylene)-COOH or —(C₁-C₂-alkylene)-COOM,
R₇ is H, —(CH₂CH₂O)ₙ—R₈ or M,
R₈ is C₁-C₂-alkyl, and
n is a number in the range of 4 to 25.

10. The modified lysine-based polymer according to Embodiment 9, wherein
R₅ is H, methyl, carboxyl (—COOH), or —COOM,
R₆ is H, methyl, carboxyl (—COOH), —COOM, —(C₁-C₂-alkylene)-COOH or —(C₁-C₂-alkylene)-COOM,
R₇ is H, —(CH₂CH₂O)ₙ—R₈ or M,
R₈ is C₁-C₂-alkyl, and
n is a number in the range of 8 to 15.

11. The modified lysine-based polymer according to Embodiment 10, wherein
R₅ is H, carboxyl (—COOH), or —COOM,
R₆ is H, carboxyl (—COOH), —COOM, —(C₁-C₂-alkylene)-COOH or —(C₁-C₂-alkylene)-COOM,
R₇ is H, —(CH₂CH₂O)ₙ—R₈ or M, and
R₈ is methyl.

12. The modified lysine-based polymer according to any of preceding Embodiments, which is a modified homopolymer of lysine.

13. The modified lysine-based polymer according to any of preceding Embodiments 1 to 11, which is a modified copolymer of lysine comprising more than 50 mol % of structural units from lysine monomer and less than 50 mol % of structural units from at least one dicarboxylic acid or amide-forming derivative thereof.

14. The modified lysine-based polymer according to Embodiment 13, which comprises
(A) 60 to 99 mol % of structural units from lysine monomer,
(B) 1 to 40 mol % of structural units from at least one dicarboxylic acid of formula (I) or amide-forming derivative thereof

HOOC—R₁—COOH (I)
wherein
R₁ is a direct bond or an aliphatic linear hydrocarbylene, which is unsubstituted or substituted with at least one group selected from unsubstituted or substituted alkyl, unsubstituted or substituted alkoxy, unsubstituted or substituted alkylthio, unsubstituted or substituted alkylamino, di(alkyl) amino, alkylidene, hydroxyl, mercapto, amino and halogen.

15. The modified lysine-based polymer according to Embodiment 14, which comprises (B) structural units from at least one dicarboxylic acid of formula (I) or amide-forming derivative thereof wherein R₁ is a direct bond or an aliphatic linear C₁-C₂₄-hydrocarbylene which is unsubstituted or substituted with at least one group selected from unsubstituted or substituted C₁-C₁₈-alkyl, unsubstituted or substituted C₁-C₁₈-alkoxy, unsubstituted or substituted C₁-C₁₈-alkylthio, unsubstituted or substituted C₁-C₁₈-alkylamino, di(C₁-C₁₈-alkyl)amino, C₁-C₆-alkylidene, hydroxyl, mercapto, amino and halogen.

16. The modified lysine-based polymer according to Embodiment 15, which comprises (B) structural units from at least one dicarboxylic acid of formula (I) or amide-forming derivative thereof wherein R₁ is a direct bond or an aliphatic linear C₁-C₁₈-hydrocarbylene which is unsubstituted or substituted with at least one group selected from unsubstituted or substituted C₁-C₁₂-alkyl, unsubstituted or substituted C₁-C₁₂-alkoxy, unsubstituted or substituted C₁-C₁₂-alkylthio, unsubstituted or substituted C₁-C₁₂-alkylamino, di(C₁-C₁₂-alkyl)amino, C₁-C₄-alkylidene, hydroxyl, mercapto, amino and halogen.

17. The modified lysine-based polymer according to Embodiment 16, which comprises (B) structural units from at least one dicarboxylic acid of formula (I) or amide-forming derivative thereof wherein R₁ is a direct bond or an aliphatic linear C₁-C₁₂-hydrocarbylene which is unsubstituted or substituted with at least one group selected from unsubstituted or substituted C₁-C₈-alkyl, unsubstituted or substituted C₁-C₈-alkoxy, unsubstituted or substituted C₁-C₈-alkylthio, unsubstituted or substituted C₁-C₈-alkylamino, di(C₁-C₈-alkyl)amino, C₁-C₄-alkylidene, hydroxyl, mercapto, amino and halogen.

18. The modified lysine-based polymer according to Embodiment 17, which comprises (B) structural units from at least one dicarboxylic acid of formula (I) or amide-forming derivative thereof wherein R₁ is a direct bond, C₁-C₁₂-alkylene or C₂-C₁₂-alkenylene which are unsubstituted or substituted with at least one group selected from unsubstituted or substituted C₁-C₄-alkyl, unsubstituted or substituted C₁-C₄-alkoxy, unsubstituted or substituted C₁-C₄-alkylthio, unsubstituted or substituted C₁-C₄-alkylamino, di(C₁-C₄-alkyl)amino, C₁-C₄-alkylidene, hydroxyl, mercapto, amino and halogen.

19. The modified lysine-based polymer according to Embodiment 18, which comprises (B) structural units from at least one dicarboxylic acid of formula (I) or amide-forming derivative thereof wherein R₁ is a direct bond, C₁-C₁₂-alkylene or C₂-C₁₂-alkenylene which are unsubstituted or substituted with at least one group selected from unsubstituted or substituted C₁-C₄-alkyl C₁-C₄-alkylidene, hydroxyl, mercapto and amino.

20. The modified lysine-based polymer according to Embodiment 19, which comprises (B) structural units from at least one dicarboxylic acid of formula (I) or amide-forming derivative thereof wherein R₁ is a direct bond, C₁-C₁₂-alkylene or C₂-C₁₂-alkenylene which are unsubstituted or substituted with at least one group selected from unsubstituted or substituted C₁-C₄-alkyl, C₁-C₂-alkylidene, hydroxyl and amino, preferably at least one of oxalic acid, malonic acid, succinic acid, maleic acid and fumaric acid, tartaric acid, aspartic acid, glutaric acid, itaconic acid, glutamic acid, adipic acid, pimelic acid, suberic acid, azelaic acid, sebacic acid, undecanedioic acid and dodecanedioic acid.

21. The modified lysine-based polymer according to any of preceding Embodiments 14 to 20, which comprises
(A) 70 to 97 mol % of the structural units from lysine monomer; and
(B) 3 to 30 mol % of the structural units from at least one dicarboxylic acid of formula (I) or amide-forming derivative thereof.

22. The modified lysine-based polymer according to Embodiment 21, which comprises
(A) 75 to 97 mol % of the structural units from lysine monomer; and
(B) 4 to 25 mol % of the structural units from at least one dicarboxylic acid of formula (I) or amide-forming derivative thereof.

23. The modified lysine-based polymer according to Embodiment 22, which comprises
(A) 75 to 95 mol % of the lysine structural units; and
(B) 5 to 25 mol % of the dicarboxylic acid structural units.

24. The modified lysine-based polymer according to any of preceding Embodiments, which has a degree of modification via Michael addition of at least 10%, for example at least 20%.

25. The modified lysine-based polymer according to any of preceding Embodiments, which has a weight average molecular weight (Mw) in the range of 600 to 20,000 g/mol, and/or has a number average molecular weight (Mn) in the range of 500 to 20,000 g/mol.

26. A detergent composition, preferably a laundry detergent composition, which comprises the modified lysine-based polymer according to any of preceding Embodiments 1 to 25.

27. The detergent composition according to Embodiment 26, wherein the detergent composition comprises the modified lysine-based polymer in an amount of 0.5 to 30%, preferably 1 to 25%, and more preferably 1 to 15% by weight based on the total solid content of the detergent composition.

28. The detergent composition according to Embodiment 25 or 26, which comprises 2-phenoxyethanol, preferably in an amount of 2 ppm to 5%, more preferably 0.1 to 2% by weight, based on the total weight of the detergent composition.

29. The detergent composition according to Embodiment 25 or 26, which comprises 4,4′-dichloro-2-hydroxydiphenylether, preferably in an amount of 0.001 to 3%, preferably 0.002 to 1%, more preferably 0.01 to 0.6%, based on the total weight of the detergent composition.

30. The detergent composition according to any of preceding Embodiments 26 to 29, which comprises at least one enzyme, preferably at least one enzyme selected from the group consisting of proteases, amylases, lipases, cellulases, mannanases, xylanases, DNases, dispersins, pectinases, oxidoreductases, and cutinases.

31. Use of the modified lysine-based polymer as defined in any of Embodiments 1 to 25 in a detergent composition, particularly a laundry detergent composition.

32. Use of the modified lysine-based polymer as defined in any of Embodiments 1 to 25 as a dispersing agent.

33. A method of preserving an aqueous detergent composition comprising the modified lysine-based polymer according to any of preceding Embodiments 1 to 25 against microbial contamination or growth, which comprises adding 2-phenoxyethanol in the detergent composition.

34. A method of laundering fabric or cleaning hard surfaces, which comprises an antimicrobial treatment of a fabric or a hard surface with a detergent composition comprising the modified lysine-based polymer according to any of preceding Embodiments 1 to 25 and 4,4′-dichloro-2-hydroxydiphenylether.

The following Examples are provided to illustrate the present invention, which however are not intended to limit the present invention.

### EXAMPLES

### Description of Materials Used in Examples

| | |
|---|---|
| Anionic surfactant LAS | (C₁₀-C₁₃) alkylbenzene sulfonic acid Sodium Salt, commercially |
| | available from BASF |
| Anionic surfactant AES | C₁₂C₁₄ fatty alcohol ether sulfate (2EO), sodium salt, commercially |
| | available from BASF |
| Anionic surfactant | Linear n-C₁₀C₁₃-alkyl benzene sulfonate, sodium salt, active content |
| LDBS 55 | 55%, commercially available from BASF |
| Anionic surfactant | Sodium dodecylbenzenesulfonate, 38% active, commercially |
| SDBS-40 | available from Stepan Company |
| Softener | Dipalmitoylethylhydroxyethylmonium methosulfate, commercially |
| Esterquat 56 | available from BASF |
| Emery ® 622 | Refined coconut fatty acid, C₈-₁₈, available from Emery |
| | Oleochemicals |
| Edenor ® K12-18 | Coco fatty acid, available from Emery Oleochemicals |
| Non-ionic surfactant | C₁₀-Guerbet alcohol alkoxylate (6 EO), 100% active, commercially |
| LA 60 | available from BASF |
| Modified PEI-1 | Carboxymethylated polyethyleneimine, aqueous solution, solid |
| | content 40%, commercially available from BASF |
| Modified PEI-2 | Ethoxylated polyethyleneimine (EPEI), Mw 14,000 g/mol, wt % N: |
| | 18.19, commercially available from BASF |
| Non-ionic surfactant | Ethoxylated C₁₃C₁₅-oxo alcohol (7EO), commercially available from |
| AEO-1 | BASF |
| Non-ionic surfactant | Ethoxylated C₁₂C₁₄-fatty alcohol, (7EO), commercially available from |
| AEO-2 | BASF |
| Soap | Coconut oil fatty acid |
| Anionic surfactant | Sodium laureth sulfate (C₁₀-C₁₆ fatty alcohol ethersulfate + 3 EO), |
| SLES | commercially available from BASF |
| Tinosan ® HP 100 | A solution of 30 wt % 4,4′-dichloro-2-hydroxydiphenylether in 1,2- |
| | propyleneglycol, commercially available from BASF |
| Protectol ® PE | 2-Phenoxyethanol, commercially available from BASF |

### Determination of Molecular Weights

The number average (Mn) and weight average (Mw) molecular weights of the modified lysine-based polymers prepared in following Examples were determined by measuring the unmodified lysine-based polymers with gel permeation chromatography (GPC) and then converting the measured values to the molecular weights of the modified polymers based on corresponding degree of modification (DM). The definition and determination of DM for modified lysine-based polymers via Michael addition are as described hereinabove. The DM for carboxymethylated lysine-based polymers is defined in accordance with following equation and determined in accordance with a similar procedure similar to that for the modified lysine-based polymers via Michael addition,

$$DM = \frac{( moles of carboxymethyl groups )}{\begin{matrix}2 \times ( moles of structural units of lysine + moles of \\ dicarboxylic acid structural units having an amino when present )\end{matrix}} \times 100 \%$$

The unmodified lysine-based polymers were analyzed in an aqueous eluent containing 0.1 M NaCl and 0.1 wt % trifluoroacetic acid through a cascade of columns (namely, TSKgel G4000, G3000, G3000, 300×7.8 mm) at 35° C. and flow rate of 0.8 ml/min. For the analysis, the unmodified polymers were dissolved in the eluent at the concentration of 1.5 mg/ml at room temperature and filtered through a 0.22 μm membrane, 2 hours before injection of 100 UL in an Agilent 1100 chromatographic system. The relative molecular weight was characterized by refractive index detection against a calibration curve obtained with polyvinyl pyrrolidone standards, ranging between 620 and 1,060,000 g/mol.

### Identification of Polymer Compositions

All polymer compositions were confirmed by 1H-NMR spectrum.

### Preparation Examples

### Example 1: Modified Lysine Homopolymer Via Michael Addition of Acrylic Acid

A 500 ml four-neck flask equipped with stirrer, internal thermometer, gas inlet tube, condenser with reduced-pressure connection and receiver, was charged with 350 g of an aqueous solution of L-lysine (71 wt %). The mixture was heated with stirring to an internal temperature of 160° C., with continuous water separation. After a reaction time of 3 hours, water was distilled off further under reduced pressure (670 mbar). Finally, 103 g of water distillate had been collected and the highly viscous polymer was discharged to a silicone container as fast as possible, while it was still hot and flowable. The k-value of the lysine homopolymer was determined as 10.1.

A 500 ml four-neck flask equipped with a stirrer, an internal thermometer, a gas inlet tube, a condenser, was charged with 50 g of the lysine homopolymer, 64.74 g of acrylic acid and 114.74 g of DI water. The pH of the mixture was nearly 3 and adjusted to precisely 3 by adding a small amount of either HCl (1 mol/L) or NaOH (1 mol/L) solution. The mixture was then heated with stirring to an internal temperature of 70° C. for 24 hours. After the reaction mixture was cooled down to 25° C., the modified polymer was precipitated with excess acetone (1:10 by weight). After three successive precipitation steps, the supernatant was transparent and colorless and the precipitate was dried over 48 hours in a vacuum oven at 40° C. to obtain the final product. The solid content was 100% and the active content was 99.1 wt %, as determined by ¹H NMR. The degree of modification (DM) of the polymer as determined by ¹H NMR was 35%, and the molecular weights as determined were Mn=718 g/mol and Mw=883 g/mol.

### Example 2: Modified Lysine Homopolymer Via Michael Addition of Acrylic Acid

A 500 ml four-neck flask equipped with stirrer, internal thermometer, gas inlet tube, condenser with reduced-pressure connection and receiver, was charged with 350 g of an aqueous solution of L-lysine (71 wt %). The mixture was heated with stirring to an internal temperature of 160° C., with continuous water separation. After a reaction time of 3.5 hours, water was distilled off further under reduced pressure (670 mbar). Finally, 102 g of water distillate had been collected and the highly viscous polymer was discharged to a silicone container as fast as possible, while it was still hot and flowable. The k-value of the lysine homopolymer was determined as 10.1.

A 500 ml four-neck flask equipped with a stirrer, an internal thermometer, a gas inlet tube, a condenser, was charged with 15 g of the lysine homopolymer, 19.42 g of acrylic acid and 34.42 g of DI water. The pH of the mixture was nearly 3 and adjusted to precisely 3 by adding a small amount of either HCl (1 mol/L) or NaOH (1 mol/L) solution. The mixture was then heated with stirring to an internal temperature of 70° C. for 24 hours. After the reaction mixture was cooled down to 25° C., the modified polymer was precipitated with excess acetone (1:10 by weight). After three successive precipitation steps, the supernatant was transparent and colorless and the precipitate was dried over 48 hours in a vacuum oven at 40° C. to obtain the final product. The solid content was 100% and the active content was 99.1 wt %, as determined by ¹H NMR. The degree of modification (DM) of the polymer as determined by ¹H NMR was 52%, and the molecular weights as determined were Mn=817 g/mol and Mw=1,005 g/mol.

### Example 3: Modified Lysine Homopolymer Via Michael Addition of Acrylic Acid

A 500 ml four-neck flask equipped with stirrer, internal thermometer, gas inlet tube, condenser with reduced-pressure connection and receiver, was charged with 350 g of aqueous solution of L-lysine (71 wt %). The mixture was heated with stirring to an internal temperature of 160° C., with continuous water separation. After a reaction time of 3.5 hours, water was distilled off further under reduced pressure (670 mbar). Finally, 102 g of water distillate had been collected and the highly viscous polymer was discharged to a silicone container as fast as possible, while it was still hot and flowable. The k-value of the lysine homopolymer was determined as 10.1.

A 500 ml four-neck flask equipped with a stirrer, an internal thermometer, a gas inlet tube, a condenser, was charged with 30 g of the lysine homopolymer, 38.85 g of acrylic acid and 68.84 g of DI water. The pH of the mixture was nearly 3 and adjusted to precisely 3 by adding a small amount of either HCl (1 mol/L) or NaOH (1 mol/L) solution. The mixture was then heated with stirring to an internal temperature of 70° C. for 24 hours. After the reaction mixture was cooled down to 25° C., the modified polymer was precipitated with excess acetone (1:10 by weight). After three successive precipitation steps, the supernatant was transparent and colorless and the precipitate was dried over 48 hours in a vacuum oven at 40° C. to obtain the final product. The solid content was 100% and the active content was 96.0 wt %, as determined by ¹H NMR. The degree of modification (DM) of the polymer as determined by ¹H NMR was 68%, and the molecular weights as determined were Mn=911 g/mol and Mw=1,120 g/mol.

### Example 4: Modified Lysine Homopolymer Via Michael Addition of Acrylic Acid

A 500 ml four-neck flask equipped with stirrer, internal thermometer, gas inlet tube, condenser with reduced-pressure connection and receiver, was charged with 350 g of an aqueous solution of L-lysine (71 wt %). The mixture was heated with stirring to an internal temperature of 160° C., with continuous water separation. After a reaction time of 3 hours, water was distilled off further under reduced pressure (670 mbar). Finally, 103 g of water distillate had been collected and the highly viscous polymer was discharged to a silicone container as fast as possible, while it was still hot and flowable. The k-value of the lysine homopolymer was determined as 10.1.

A 250 ml four-neck flask equipped with a stirrer, an internal thermometer, a gas inlet tube, a condenser, was charged with 25 g of the lysine homopolymer, 32 g of acrylic acid and 57 g of DI water. The pH of the mixture was nearly 3 and adjusted to precisely 3 by adding a small amount of either HCl (1 mol/L) or NaOH (1 mol/L) solution. The mixture was then heated with stirring to an internal temperature of 70° C. for 24 hours. After the reaction mixture was cooled down to 25° C., the modified polymer was precipitated with excess acetone (1:10 by weight). After three successive precipitation steps, the supernatant was transparent and colorless and the precipitate was dried over 48 hours in a vacuum oven at 40° C. to obtain the final product. The solid content was 100% and the active content was 99.5 wt %, as determined by ¹H NMR. The degree of modification (DM) of the polymer as determined by ¹H NMR was 98%, and the molecular weights as determined were Mₙ=1,086 g/mol and M_{w}=1,336 g/mol.

### Example 5: Modified Lysine Homopolymer Via Michael Addition of Acrylic Acid

A 1000 ml four-neck flask equipped with a stirrer, an internal thermometer, a gas inlet tube, a condenser with reduced-pressure connection and a Dean-Stark receiver, was charged with 500 g of an aqueous solution of L-lysine (50 wt %). The mixture was heated with stirring to an internal temperature of 160° C., with continuous water separation. After a reaction time of 4.5 hours, water was distilled off further under reduced pressure (670 mbar). Finally, 272 g of water distillate had been collected and the highly viscous polymer was discharged to a silicone container as fast as possible while it was still hot and flowable. The k-value of the lysine homopolymer was determined as 12.5.

A 250 ml four-neck flask equipped with a stirrer, an internal thermometer, a gas inlet tube, a condenser, was charged with 25 g of the lysine homopolymer, 16 g of acrylic acid and 57 g of DI water. The pH of the mixture was nearly 3 and adjusted to precisely 3 by adding a small amount of either HCl (1 mol/L) or NaOH (1 mol/L) solution. The mixture was then heated with stirring to an internal temperature of 70° C. for 24 hours. After the reaction mixture was cooled down to 25° C., the modified polymer was precipitated with excess acetone (1:10 by weight). After three successive precipitation steps, the supernatant was transparent and colorless and the precipitate was dried over 48 hours in a vacuum oven at 40° C. to obtain the final product. The solid content was 100% and the active content was 99.0 wt %, as determined by ¹H NMR. The degree of modification (DM) of the polymer as determined by ¹H NMR was 30%, and the molecular weights as determined were Mₙ=1,936 g/mol and M_{w}=3,595 g/mol.

### Example 6: Modified Poly(Lysine-Co-Tartaric Acid) with a Molar Ratio of Lysine to Tartaric Acid at 90:10 Via Michael Addition of Acrylic Acid

A 1000 ml four-neck flask equipped with stirrer, internal thermometer, gas inlet tube, condenser with reduced-pressure connection and receiver, was charged with 400 g of lysine, 46 g of tartaric acid and 190 g DI water. The mixture was heated with stirring to an internal temperature of 160° C. After a reaction time of 2 hours 25 min, water was distilled off further under reduced pressure (670 mbar). Finally, 221 g of water distillate had been collected and the highly viscous polymer was discharged to a silicone container as fast as possible, while it was still hot and flowable. The k-value of the lysine copolymer was determined as 11.9.

A 500 ml four-neck flask equipped with a stirrer, an internal thermometer, a gas inlet tube, a condenser, was charged with 80 g of the lysine copolymer, 37.17 g of acrylic acid and 117 g of DI water. The pH of the mixture was nearly 3 and adjusted to precisely 3 by adding a small amount of either HCl (1 mol/L) or NaOH (1 mol/L) solution. The mixture was then heated with stirring to an internal temperature of 70° C. for 24 hours. After the reaction mixture was cooled down to 25° C., the modified polymer was precipitated with excess acetone (1:10 by weight). After three successive precipitation steps, the supernatant was transparent and colorless and the precipitate was dried over 48 hours in a vacuum oven at 40° C. to obtain the final product. The solid content was 100% and the active content was 98.4 wt %, as determined by ¹H NMR. The degree of modification (DM) of the polymer as determined by ¹H NMR was 22%, and the molecular weights as determined were Mₙ=1,253 g/mol and M_{w}=2,605 g/mol.

### Example 7: Modified Poly(Lysine-Co-Tartaric Acid) with a Molar Ratio of Lysine to Tartaric Acid at 80:20 Via Michael Addition of Acrylic Acid

A 500 ml four-neck flask equipped with stirrer, internal thermometer, gas inlet tube, condenser with reduced-pressure connection and receiver, was charged with 200 g of lysine, 22.82 g of tartaric acid and 108 g of DI water. The mixture was heated with stirring to an internal temperature of 160° C. for 2 h 50 min, with continuous water separation. When 108 g distilled water was collected, additional 28.52 g of tartaric acid was introduced into the reactor. After a total reaction time of 3 h 50 min, water was distilled off further under reduced pressure (900 mbar). Finally, 132 g of water distillate had been collected and the highly viscous polymer was discharged to a silicone container as fast as possible, while it was still hot and flowable. The k-value of the lysine was determined as 12.3.

A 500 ml four-neck flask equipped with a stirrer, an internal thermometer, a gas inlet tube, a condenser, was charged with 60 g of the lysine copolymer, 30.88 g of acrylic acid and 120 g of DI water. The pH of the mixture was nearly 3 and adjusted to precisely 3 by adding a small amount of either HCl (1 mol/L) or NaOH (1 mol/L) solution. The mixture was then heated with stirring to an internal temperature of 70° C. for 24 hours. After the reaction mixture was cooled down to 25° C., the modified polymer was precipitated with excess acetone (1:10 by weight). After three successive precipitation steps, the supernatant was transparent and colorless and the precipitate was dried over 48 hours in a vacuum oven at 40° C. to obtain the final product. The solid content was 100% and the active content was 93.28 wt %, as determined by ¹H NMR. The degree of modification (DM) of the polymer as determined by ¹H NMR was 37%, and the molecular weights as determined were Mn=1,021 g/mol and Mw=1,799 g/mol.

### Example 8: Modified Poly(Lysine-Co-Adipic Acid) with a Molar Ratio of Lysine to Adipic Acid at 80:20 Via Michael Addition of Acrylic Acid

A 500 ml four-neck flask equipped with stirrer, internal thermometer, gas inlet tube, condenser with reduced-pressure connection and receiver, was charged with 200 g of lysine, 22.21 g of adipic acid and 100 g of DI water. The mixture was heated with stirring to an internal temperature of 160° C. for 2 h 50 min, with continuous water separation. Then, additional 27.77 g of adipic acid was introduced into the reactor. After a total reaction time of 3 h 50 min, water was distilled off further under reduced pressure (900 mbar). Finally, 117 g of water distillate had been collected and the highly viscous polymer was discharged to a silicone container as fast as possible, while it was still hot and flowable. The k-value of the lysine copolymer was determined as 11.2.

A 250 ml four-neck flask equipped with a stirrer, an internal thermometer, a gas inlet tube, a condenser, was charged with 36.94 g of the lysine copolymer, 19.12 g of acrylic acid and 60 g of DI water. The pH of the mixture was nearly 3 and adjusted to precisely 3 by adding a small amount of either HCl (1 mol/L) or NaOH (1 mol/L) solution. The mixture was then heated with stirring to an internal temperature of 70° C. for 24 hours. After the reaction mixture was cooled down to 25° C., the modified polymer was precipitated with excess acetone (1:10 by weight). After three successive precipitation steps, the supernatant was transparent and colorless and the precipitate was dried over 48 hours in a vacuum oven at 40° C. to obtain the final product. The solid content was 100% and the active content was 96.9 wt %, as determined by ¹H NMR. The degree of modification (DM) of the polymer as determined by ¹H NMR was 38.24%, and the molecular weights as determined were Mn=934 g/mol and Mw=1,705 g/mol.

### Example 9: Modified Lysine Homopolymer Via Michael Addition of Itaconic Acid

A 500 ml four-neck flask equipped with stirrer, internal thermometer, gas inlet tube, condenser with reduced-pressure connection and receiver, was charged with 350 g of aqueous solution of L-lysine (71 wt %). The mixture was heated with stirring to an internal temperature of 160° C., with continuous water separation. After a reaction time of 3 hours, water was distilled off further under reduced pressure (670 mbar). Finally, 104 g of water distillate had been collected and the highly viscous polymer was discharged to a silicone container as fast as possible, while it was still hot and flowable. The k-value of the lysine homopolymer was determined as 10.2.

A 250 ml four-neck flask equipped with a stirrer, an internal thermometer, a gas inlet tube, a condenser, was charged with 20 g of the lysine homopolymer, 46.75 g of itaconic acid and 66.75 g of DI water. The pH of the mixture was nearly 4 and adjusted to precisely 4 by adding a small amount of either HCl (1 mol/L) or NaOH (1 mol/L) solution. The mixture was then heated with stirring to an internal temperature of 70° C. for 24 hours. After the reaction mixture was cooled down to 25° C., the modified polymer was precipitated with excess acetone (1:10 by weight). After three successive precipitation steps, the supernatant was transparent and colorless and the precipitate was dried over 48 hours in a vacuum oven at 40° C. to obtain the final product. The final product has a solid content of 100% and an active content of 67.4 wt %, as determined by ¹H NMR. The degree of modification (DM) of the polymer as determined by ¹H NMR was 22%, and the molecular weights as determined were Mₙ=740 g/mol and M_{w}=911 g/mol.

### Example 10: Modified Lysine Homopolymer Via Michael Addition of Maleic Acid

A 500 ml four-neck flask equipped with stirrer, internal thermometer, gas inlet tube, condenser with reduced-pressure connection and receiver, was charged with 350 g of an aqueous solution of L-lysine (71 wt %). The mixture was heated with stirring to an internal temperature of 160° C., with continuous water separation. After a reaction time of 3 hours, water was distilled off further under reduced pressure (670 mbar). Finally, 104 g of water distillate had been collected and the highly viscous polymer was discharged to a silicone container as fast as possible, while it was still hot and flowable. The k-value of the lysine homopolymer was determined as 10.2.

A 250 ml four-neck flask equipped with a stirrer, an internal thermometer, a gas inlet tube, a condenser, was charged with 25 g of the lysine homopolymer, 52 g of maleic acid and 77 g of DI water. The pH of the mixture was adjusted to 10 by adding 29 g of solid NaOH. The mixture was then heated with stirring to an internal temperature of 95° C. for 24 hours. After the reaction mixture was cooled down to 25° C., the unreacted maleic acid was precipitated by adjusting pH to 3.2 via addition of HCl solution (36 wt %). The filtrate was collected and lyophilized to obtain the final product, having a solid content of 100% and an active content of 92.1 wt %, as determined by ¹H NMR. The degree of modification (DM) of the polymer as determined by ¹H NMR was 73%, and the molecular weights as determined were Mₙ=1,186 g/mol and M_{w}=1,459 g/mol.

### Example 11: Modified ε-Polylysine Via Michael Addition of Itaconic Acid

A 250 ml four-neck flask equipped with a stirrer, an internal thermometer, a gas inlet tube, a condenser, was charged with 20 g of ε-polylysine, 46.75 g of itaconic acid and 66.75 g of DI water. The pH of the mixture was nearly 4 and adjusted to precisely 4 by adding a small amount of either HCl (1 mol/L) or NaOH (1 mol/L) solution. The mixture was then heated with stirring to an internal temperature of 70° C. for 24 hours. After the reaction mixture was cooled down to 25° C., the modified polymer was precipitated with excess acetone (1:10 by weight). The final product has a solid content of 100% and an active content of 74.78 wt %, as determined by ¹H NMR. The degree of modification (DM) of the polymer as determined by ¹H NMR was 33%, and the molecular weights as determined were Mn=10,091 g/mol and Mw=10,574 g/mol.

### Example 12: Modified ε-Polylysine Via Michael Addition of Maleic Acid

A 250 ml four-neck flask equipped with a stirrer, an internal thermometer, a gas inlet tube, a condenser, was charged with 25 g of ¿-polylysine, 52.14 g of maleic acid and 77.14 g of DI water. The pH of the mixture was adjusted to 1.4 by adding HCl solution (36 wt %). The mixture was then heated with stirring to an internal temperature of 95° C. for 24 hours. After the reaction mixture was cooled down to 25° C., the modified polymer was precipitated with excess acetone (1:10 by weight). After three successive precipitation steps, the supernatant was transparent and colorless and the precipitate was dried over 48 hours in a vacuum oven at 40° C. to obtain the final product. The final product has a solid content of 100% and an active content of 68.77 wt %, as determined by ¹H NMR. The degree of modification (DM) of the polymer as determined by ¹H NMR was 37%, and the molecular weights as determined were Mₙ=10,089 g/mol and M_{w}=10,572 g/mol.

### Example 13: Modified ε-Polylysine Via Michael Addition of Acrylic Acid

A 250 ml four-neck flask equipped with a stirrer, an internal thermometer, a gas inlet tube, a condenser, was charged with 30 g of ε-polylysine, 38.84 g of acrylic acid and 68.84 g of DI water. The pH of the mixture was nearly 3 and adjusted to precisely 3 by adding a small amount of either HCl (1 mol/L) or NaOH (1 mol/L) solution. The mixture was then heated with stirring to an internal temperature of 70° C. for 24 hours. After the reaction mixture was cooled down to 25° C., the modified polymer was precipitated with excess acetone (1:10 by weight). After three successive precipitation steps, the supernatant was transparent and colorless and the precipitate was dried over 48 hours in a vacuum oven at 40° C. to obtain the final product. The final product has a solid content of 100% and an active content of 95.86 wt %, as determined by ¹H NMR. The degree of modification (DM) of the polymer as determined by ¹H NMR was 65%, and the molecular weights as determined were Mₙ=10,553 g/mol and M_{w}=11,058 g/mol.

### Example 14: Modified Lysine Homopolymer Via Michael Addition of mPEG-Acrylate

A 500 ml four-neck flask equipped with stirrer, internal thermometer, gas inlet tube, condenser with reduced-pressure connection and receiver, was charged with 350 g of an aqueous solution of L-lysine (71 wt %). The mixture was heated with stirring to an internal temperature of 160° C., with continuous water separation. After a reaction time of 3 hours, water was distilled off further under reduced pressure (670 mbar). Finally, 106 g of water distillate had been collected and the highly viscous polymer was discharged to a silicone container as fast as possible, while it was still hot and flowable. The k-value of the lysine homopolymer was determined as 10.6.

A 250 ml four-neck flask equipped with a stirrer, an internal thermometer, a gas inlet tube, a condenser, was charged with 8.54 g of the lysine homopolymer, 32.03 g of mPEGA 480 (Poly(ethylene glycol) methyl ether acrylate (mPEG-acrylate, Mₙ=480) and 121.7 g of glycerol. The mixture was heated with stirring to an internal temperature of 70° C. for 4 h. After the reaction mixture was cooled down to 25° C., the solution was collected as a final product with a solid content of 23.23% and an active content of 23.23 wt %, as determined by ¹H NMR. The degree of modification (DM) of the polymer as determined by ¹H NMR was 26%, and the molecular weights as determined were Mn=2,233 g/mol and Mw=3,388 g/mol.

### Example 15: Modified Lysine Homopolymer Via Michael Addition of mPEG-Acrylate

A 1000 ml four-neck flask equipped with a stirrer, an internal thermometer, a gas inlet tube, a condenser with reduced-pressure connection and a Dean-Stark receiver, was charged with 500 g of an aqueous solution of L-lysine (50 wt %). The mixture was heated with stirring to an internal temperature of 160° C., with continuous water separation. After a reaction time of 4 hours, water was distilled off further under reduced pressure (670 mbar). Finally, 264 g of water distillate was collected and the highly viscous polymer was discharged to a silicone container as fast as possible while it was still hot and flowable. The k-value of the lysine homopolymer was determined as 11.2.

A 250 ml four-neck flask equipped with a stirrer, an internal thermometer, a gas inlet tube, a condenser, was charged with 8.54 g of the lysine homopolymer, and 102.5 g of water. The pH of the solution was adjusted to 6 by addition of HCl (1 mol/L) solution. Then, 25.62 g of mPEGA 480 was added and the mixture was heated with stirring to an internal temperature of 60° C. for 8 h. After the reaction mixture was cooled down to 25° C., the solution was collected as a final product with a solid content of 50.8% and an active content of 37.6 wt %, as determined by ¹H NMR. The degree of modification (DM) of the polymer as determined by ¹H NMR was 24%, and the molecular weights as determined were Mₙ=2,693 g/mol and M_{w}=3,884 g/mol.

### Example 16: Modified ε-Polylysine Via Michael Addition with mPEG-Acrylate

A 500 ml four-neck flask equipped with a stirrer, an internal thermometer, a gas inlet tube, a condenser, was charged with 8.54 g of linear &-polylysine, and 179.3 g of water. The pH of the solution was adjusted to 6 by addition of HCl (1 mol/L) solution. Then, 51.23 g of mPEGA 480 was added and the mixture was heated with stirring to an internal temperature of 60° C. for 8 hours. After the reaction mixture was cooled down to 25° C., the solution was collected as a final product with a solid content of 49.4% and an active content of 27.1 wt %, as determined by ¹H NMR. The degree of modification (DM) of the polymer as determined by ¹H NMR was 39%, and the molecular weights as determined were Mₙ=23,749 g/mol and M_{w}=24,885 g/mol.

### Example 17: Modified Poly(Lysine-Co-Tartaric Acid) with a Molar Ratio of Lysine to Tartaric Acid at 80:20 Via Michael Addition of mPEG-Acrylate

A 500 ml four-neck flask equipped with a stirrer, an internal thermometer, a gas inlet tube, a condenser with reduced-pressure connection and a Dean-Stark receiver, was charged with 165 g of an aqueous solution of L-lysine (50 wt %) and 9.4 g of tartaric acid suspended in 9.5 g of water. The mixture was heated with stirring to an internal temperature of 160° C. for 2 h 25 min, with continuous water separation. Then, additional 11.8 g of tartaric acid was introduced into the reactor. Finally, 94 g of water distillate was collected and the highly viscous polymer was discharged to a silicone container as fast as possible while it was still hot and flowable. The k-value of the lysine copolymer was determined as 11.5.

A 250 ml four-neck flask equipped with a stirrer, an internal thermometer, a gas inlet tube, a condenser, was charged with 8.54 g of the lysine copolymer, and 71.73 g of water. The pH of the solution was adjusted to 6 by addition of HCl (1 mol/L) solution. Then, 15.37 g of mPEGA480 was added and the mixture was heated with stirring to an internal temperature of 60° C. for 8 hours. After the reaction mixture was cooled down to 25° C., the solution was collected as a final product with a solid content of 47.0% and an active content of 35.7 wt %, as determined by ¹H NMR. The degree of modification (DM) of the polymer as determined by ¹H NMR was 17%, and the molecular weights as determined were Mₙ=1,295 g/mol and M_{w}=1,709 g/mol.

### Application Examples

### I. Anti-Greying Performance

### Test I.1

A laundering process was simulated in lab using a Terg-o-meter (RHLG-IV, from Shanghai Bank Equipment Co. Ltd, China.) which includes 12 barrels with respective rotor blades as washing units, generally following GBT 13174-2008.

Before washing, all the fabrics used were pre-treated with a softener. 7 g of softener formulation shown in Table 1 was diluted in 10 L of tap water (25° C.) and transferred to a mini washing machine (Hair MW-PQ28SW). 300 g of fabrics to be used were put in the washing machine and stirred for 3 min. The treated fabric without rinsing were then transferred to another washing machine of same model to spin dry for 1 minute, and then dried at 40° C. for 1 hour.

The washing units were operated at the stirring speed of 120 rotation per minute (rpm) and each contains 1 L of hard water (100 ppm Ca: Mg=3:2). 3 pieces of each type of white test fabrics (15 pieces in total) were washed in the same barrel together with 10 g of a red clay and oil mixture at 30° C. in a wash liquor comprising 0.93 g of a detergent with the formulation as shown in Table 2. After the washing, the fabrics were removed from the washing units, drained and rinsed twice in 10 L of tap water for 30 seconds. The wash cycle was repeated another two times with a new red clay and oil mixture and a new wash liquor. After the rinsing in the third wash cycle, the test fabrics were dried in air instead. The details of the wash cycles are summarized in Table 3.

The anti-greying performance was characterized by the difference in remission of a fabric before washing but after softener treatment (R_{before}) and after 3 cycles of washing (R_{after}), by measuring the fabric with the spectrophotometer Elrepho 2000 from Datacolor at 457 nm.

The difference in remission (ΔR) is calculated in accordance with following equation:

ΔR=R_{before}−R_{after}.

The smaller the value of ΔR, the better the performance.

Results were summarized in Table 5.

TABLE 1
Softener formulation

| Ingredient | Solid Content, wt % | Active, wt % |
|---|---|---|
| Softener Esterquat 56 | 90 | 10 |
| Calcium chloride | 25 | 0.3 |

| | |
|---|---|
| Deionized water | to 100 |

Adjusting to pH 4

TABLE 2
Detergent formulation

| Ingredient | Solid Content, wt % | Active, wt % |
|---|---|---|
| Anionic surfactant LAS | 55 | 15.1 |
| Anionic surfactant AES | 70 | 23.8 |
| Non-ionic surfactant AEO-1 | 100 | 1.6 |
| Sodium citrate | 100 | 2.5 |
| Ethanol | 100 | 4 |
| Sodium sulfate | 100 | 0.3 |
| Sodium chloride | 100 | 0.1 |
| Deionized water | to 100 | |
| Additive as shown in table 5 | | 5.4 |

Adjusting to pH 8

TABLE 3

| Machine Type | Tergotometer, model (RHLG-IV) 120 rpm |
|---|---|
| Washing Liquor/g | 1000 g |
| Detergent | As shown in Table 2 |
| Detergent dosage/[g/L] | 0.93 g/L (equal to 375 ppm surfactants in beaker) |
| Hard Water/[mg | 100 ppm |
| CaCO₃/L] | |
| Ca:Mg Ratio | 3:2 |
| Fabric Type | Fabrics treated with a fabric softener with the |
| | formulation shown in Table 3): Cotton woven |
| | WFK 10A, Cotton towel WFK 12A, PES/PO |
| | woven WFK 20A, Polyester woven WFK 30A, |
| | Cotton knitted WFK 80A |
| Fabric Size/cm*cm | 3 pieces, 6*6 each |
| Fabric Amount/Piece | 15 (3 piece of each type fabric) in each leg |
| Stain Type | 10 g/L, Red Clay (JIS) - oil mixture with the |
| | formulation shown in Table 4 |
| Washing Time/min | 30 min |
| Washing Temp./° C. | 30° C. |
| Washing Cycle | 3 |
| Washing Repeat | 1 |
| Rinsing Condition | Haier Mini top-loading machine, max water level |
| | (10 L) model: Hair MW-PQ28SW |
| Dry Condition | Naturally |
| Fabric Measurement | After 3rd cycle |

TABLE 4
Clay and oil mixture

| Ingredient | Solid Content, wt % | Active, wt % |
|---|---|---|
| Red Clay (Japanese Industrial | 100 | 20 |
| Standards soil) | | |
| Peanut oil (Luhua Oil) | 100 | 3.75 |
| Mineral oil #26 | 100 | 1.25 |
| Deionized water | 100 | 75 |

TABLE 5

| Additive | ΔR, Sum of all fabrics | ΔR, Sum of cotton fabrics |
|---|---|---|
| Blank Batch | 248.87 | 152.84 |
| Modified PEI-1 | 187.04 | 118.02 |
| Modified PEI-2 | 231.41 | 148.10 |
| Example 1 | 218.52 | 127.63 |
| Example 2 | 204.16 | 120.19 |
| Example 3 | 225.01 | 131.55 |
| Example 4 | 218.57 | 132.51 |
| Example 5 | 184.56 | 110.43 |
| Example 9 | 241.87 | 147.51 |
| Example 10 | 231.03 | 136.50 |
| Example 11 | 217.87 | 132.29 |
| Example 12 | 200.05 | 124.95 |
| Example 13 | 201.55 | 122.65 |
| Example 14 | 228.99 | 144.49 |
| Example 15 | 221.37 | 140.02 |
| Example 16 | 219.95 | 140.98 |
| Example 17 | 196.31 | 123.78 |

### Test I.2

A laundering process was simulated in lab using a Terg-o-meter (RHLG-IV, from Shanghai Bank Equipment Co. Ltd, China.) which includes 12 barrels with respective rotor blades as washing units, generally following GBT 13174-2008. The washing units were operated at the same stirring speed of 120 rotation per minute (rpm) and each contains 1 L of water. White test fabrics were washed in the same barrel together with 10 g of a red clay and oil mixture at 30° C. in a wash liquor comprising a detergent with the formulation as shown in Table 6. After the washing, the fabrics were removed from the washing units, drained and rinsed twice in 10 L of tap water for 30 seconds. The wash cycle was repeated two times with a new red clay and oil mixture and a new wash liquor. After the rinsing in the third wash cycle, the test fabrics were dried in air instead. The details of the wash cycles are summarized in Table 7.

The anti-greying performance was characterized by the difference in remission of a fabric before washing (R_{before}) and after 3 cycles of washing (R_{after}), by measuring the fabric with the spectrophotometer Elrepho 2000 from Datacolor at 457 nm.

The difference in remission (ΔR) is calculated in accordance with following equation:

ΔR=R_{before}−R_{after}.

The smaller the value of ΔR, the better the performance.

TABLE 6
Detergent Formulation

| Ingredient | Amount^{a)}, wt % |
|---|---|
| Anionic Surfactant LAS | 5 |
| Anionic Surfactant AES | 10 |
| Non-ionic Surfactant AEO-1 | 5 |
| Ethanol | 1.5 |
| Sodium citrate | 0.5 |
| Additive as shown in Table 8 | 1.0 |
| Water | up to 100 |

^{a)}on a basis of active content for all ingredients

TABLE 7

| Equipment | Terg-O-meter |
|---|---|
| Detergent dosage | 2 g/L |
| Detergent | Formulation as shown in Table 6 |
| Water hardness | 2.5 mmol/L |
| Ca:Mg | 3:2 |
| Washing temperature | 30° C. |
| Wash cycles | 3 (each 30 min) |
| Washing repetitions | 1 |
| Wash liquor | 1000 ml |
| Fabric/liquor ratio | N/A |
| White test fabric | Cotton: WFK 10A, WFK 80A, WFK 12A |
| (3 pieces for each, each | PES/Co blend: WFK 20A |
| 6 × 6 cm) | Polyester: WFK 30A |
| Test soil | 10 g red clay and oil mixture |
| Rinsing Condition | Haier Mini top-loading machine, max water |
| | level (10 L) |
| Dry Condition | Naturally |

TABLE 8

| Additive | ΔR, Sum of all fabrics |
|---|---|
| Blank Batch | 277.5 |
| Modified PEI-1 | 227.0 |
| Modified PEI-2 | 273.2 |
| Example 6 | 238.00 |
| Example 7 | 195.42 |
| Example 8 | 249.90 |

### II. Primary Detergency of a Liquid Laundry Formulation

### Test II.1

The liquid laundry formulation as shown in Table 9 was measured for primary detergency in full-scale with a household washing machine, in accordance with the protocol as described in Table 10. Soil monitors were used for evaluation of the detergency for bleachable stains.

TABLE 9
Detergent Formulation

| Ingredient | Amount^{a)}, wt % |
|---|---|
| Anionic Surfactant LDBS 55 | 5 |
| Anionic Surfactant AES | 10 |
| Soap (coconut fatty acid) | 1 |
| Non-ionic Surfactant AEO-2 | 5 |
| Sodium citrate | 0.5 |
| Ethanol | 1.5 |
| Additive as shown in Table 11 | 1.0 |
| Water | up to 100 |

^{a)}on a basis of active content for all ingredients

TABLE 10

| Equipment | Midea MG80T1WS |
|---|---|
| Detergent dosage | 2 g/L |
| Detergent | Formulation as shown in Table 9 |
| Water hardness | Tap water, ~1.5 mmol/L |
| Washing temperature | 30° C. |
| Wash cycles | 1 |
| Repetitions | 2 |
| Duration of cycle | 1 h 4 min |
| Washliquor | 15 L (main wash) |
| Fabric/liquor ratio | 1 kg/4.3 L |
| Test fabric | Multisoil monitors for bleachable stains: |
| | CFT-C-BC-01/Tea for |
| | bleach at high temperature, CFT-C-BC-02/Coffee |
| Ballast fabric | 3.5 kg white fabrics (cotton:PES = 50%:50%), |
| | 1 × ballast soil sheet WFK SBL 2004 |

The primary detergency is characterized by ΔE value calculated according to DIN EN ISO 11664-4 (June 2012) in accordance with following equation:

$$Δ E = {( Δ {L}^{* 2} + Δ {a}^{* 2} + Δ {b}^{* 2} )}^{1 / 2} ,$$

$$in which$$

$$Δ {L}^{⋆} = {L}_{w a s h e d}^{⋆} - {L}_{initial}^{*} ; Δ {a}^{⋆} = {a}_{w a s h e d}^{⋆} - {a}_{initial}^{⋆} ; and Δ b = {b}_{w a s h e d}^{⋆} - {b}_{initial}^{⋆} .$$

The L*, a*, b* values were measured on the stained fabrics before and after washing with the spectrophotometer MACH 5 from Color Consult provided by CFT, NL-Vlaardingen. The higher the ΔE value, the better is the performance. Results were summarized in Table 11.

TABLE 11

| Additive | ΔE, Sum of stained fabrics with bleachable stains |
|---|---|
| Blank | 0.83 |
| Modified PEI-1 | 1.29 |
| Modified PEI-2 | 0.71 |
| Example 2 | 1.17 |

### Test II.2

The liquid laundry formulation as shown in Table 12 was measured for primary detergency in full-scale with a household washing machine, in accordance with the protocol as described in Table 13. Soil monitors were used for evaluation of the detergency for bleachable stains.

TABLE 12
Detergent Formulation

| Ingredient | Amount^{a)}, wt % |
|---|---|
| Anionic Surfactant SDBS-40 | 6.72 |
| Anionic surfactant SLES | 12.5 |
| Non-ionic surfactant LA 60 | 6.24 |
| Emery 622 | 1.80 |
| NaOH (50%) | 0.33 |
| Na Citrate 2H₂O | 2.99 |
| Propylene Glycol | 6.00 |
| Ethanol | 2.00 |
| Additive as shown in Table 14 | 1.0 |
| Water | up to 100 |

^{a)}on a basis of active content for all ingredients

TABLE 13

| Equipment | HE Maytag |
|---|---|
| Detergent dosage | 48 g/wash |
| Detergent | Formulation as shown in Table 12 |
| Water hardness | Tap water, ~1.1 mmol/L |
| Washing temperature | 30° C. |
| Wash cycles | 1 |
| Repetitions | 1 |
| Duration of cycle | HE normal wash, extra rinse, 1 h 2 min |
| Wash liquor | 38-40 L (main wash) |
| Fabric/liquor ratio | 2.72 kg/39 L |
| Test fabric: | ASTM monitors 1 and 2, cotton and |
| | polyester-cotton farbics, 2 replicates |
| | Multisoil monitors for bleachable stains: blood |
| | unaged, espresso coffee, red wine unaged, |
| | spaghetti sauce, tea with milk, tea freshly boiled |
| | Multisoil monitors for oily stains: 50/50 lard/fat, |
| | bacon grease, burnt butter, dirty motor oil, gravy |
| | from meat, olive oil with carbon black |
| Ballast fabric | 2.70 kg fabrics |
| | 8 100% cotton towels (16 in × 30 in) |
| | 10 AATCC dummy wash Ballast type 3 |
| | polyblend sheets |

The primary detergency is characterized in accordance with the protocol described in Test II.1. Results were summarized in Table 14.

TABLE 14

| | ΔE, Sum of stained fabrics | ΔE, Sum of stained fabrics |
|---|---|---|
| Additive | with bleachable stains | with oily stains |
| Blank | 85.92 | 118.08 |
| Modified PEI-1 | 88.91 | 115.69 |
| Example 7 | 86.68 | 118.83 |
| Example 8 | 89.06 | 124.01 |

III. Compatibility with Biocide in a Liquid Laundry Formulation

Liquid laundry detergent formulations were prepared, which comprises 1% by weight of the inventive polymer of Example as shown in Table 15 and/or 0.3% of the biocide Tinosan® HP 100 (from BASF) and/or 1% phenoxyethanol (Protectol® PE, BASF). The formulations were prepared by first preparing a premix containing surfactants, solvents, fatty acid, citric acid and NaOH, as shown in Table 15, and water up to 90%. This premix was prepared by adding all components to the appropriate amount of water and stirring at room temperature. Subsequently, the pH was set to pH=8.5 using NaOH. Then the final formulations were prepared by stirring at room temperature: 90% of this premix, the appropriate concentrations of the polymer and/or Tinosan® HP 100 (commercial product of BASF SE containing 30% of the antimicrobial active 4,4′-dichoro 2-hydroxydiphenylether) and/or 2-phenoxyethanol and water up 100%. For the purpose of comparison, a standard liquid detergent formulation neither containing a polymer of the invention nor a biocide was prepared.

All amounts indicated in Table 15 are provided as active ingredients.

TABLE 15

| | A | B | C | D | E | F | G | H | I | G | K | L |
|---|---|---|---|---|---|---|---|---|---|---|---|---|
| Ingredients | (comp.) | (comp.) | (comp.) | (comp.) | (inv.) | (inv.) | (inv.) | (inv.) | (inv.) | (inv.) | (inv.) | (inv.) |
| AEO | 5.4% | 5.4% | 5.4% | 5.4% | 5.4% | 5.4% | 5.4% | 5.4% | 5.4% | 5.4% | 5.4% | 5.4% |
| AES | 7.7% | 7.7% | 7.7% | 7.7% | 7.7% | 7.7% | 7.7% | 7.7% | 7.7% | 7.7% | 7.7% | 7.7% |
| LAS | 5.5% | 5.5% | 5.5% | 5.5% | 5.5% | 5.5% | 5.5% | 5.5% | 5.5% | 5.5% | 5.5% | 5.5% |
| Coco fatty acid | 2.4% | 2.4% | 2.4% | 2.4% | 2.4% | 2.4% | 2.4% | 2.4% | 2.4% | 2.4% | 2.4% | 2.4% |
| Citric acid | 3% | 3% | 3% | 3% | 3% | 3% | 3% | 3% | 3% | 3% | 3% | 3% |
| 1,2-propanediol | 6% | 6% | 6% | 6% | 6% | 6% | 6% | 6% | 6% | 6% | 6% | 6% |
| Ethanol | 2% | 2% | 2% | 2% | 2% | 2% | 2% | 2% | 2% | 2% | 2% | 2% |
| Modified lysine- | — | 1% | — | — | 1% | 1% | 1% | 1% | 1% | 1% | 1% | 1% |
| based Polymer | | Ex. 1 | | | Ex. 1 | Ex. 1 | Ex. 5 | Ex. 5 | Ex. 6 | Ex. 6 | Ex. 9 | Ex. 9 |
| Tinosan ® HP 100 | — | — | 0.3% | | 0.3% | | 0.3% | | 0.3% | | 0.3% | |
| Protectol ® PE | — | — | — | 1% | | 1% | | 1% | | 1% | | 1% |
| NaOH | Up to pH = 8.5 | | | | | | | | | | | |
| Water | Up to 100% | | | | | | | | | | | |
| Appearance | Clear, | Clear, | Clear, | Clear, | Clear, | Clear, | Clear, | Clear, | Clear, | Clear, | Clear, | Clear, |
| | slightly | slightly | slightly | slightly | slightly | slightly | slightly | slightly | slightly | slightly | slightly | slightly |
| | yellow, | yellow, | yellow, | yellow, | yellow, | yellow, | yellow, | yellow, | yellow, | yellow, | yellow, | yellow, |
| | viscous | viscous | viscous | viscous | viscous | viscous | viscous | viscous | viscous | viscous | viscous | viscous |
| | liquid | liquid | liquid | liquid | liquid | liquid | liquid | liquid | liquid | liquid | liquid | liquid |

comp.: comparative;
Inv.: inventive
AEO: C12/C14 fatty alcohol (7EO) Lutensol AO7 (BASF)
AES: Alcohol
Ethoxysulfate: Texapon N 70 (BASF)
LAS: Linear alkylbenzene sulfonate Maranil DBS/LC (BASF)
Coco fatty acid: Edenor K12-18 (Emery Oleochemicals)

It is clear from the above Table, that the polymers according to the present invention can be combined with the biocide, Tinosan® HP 100 (4,4′-dichloro-2-hydroxydiphenylether) or Protectol® PE (2-phenoxyethanol), in a liquid laundry formulation without any instability or turbidity.

### III. Biodegradability of Modified Lysine-Based Polymer

Biodegradation of polymers in wastewater was tested in triplicate using the OECD 301F manometric respirometry method. 30 mg/mL test substance is inoculated into wastewater taken from Mannheim Wastewater Treatment Plant and incubated in a closed flask at 25° C. for 28 days. The consumption of oxygen during this time is measured as the change in pressure inside the flask using an OxiTop C (WTW). Evolved CO2 is absorbed using an NaOH solution. The amount of oxygen consumed by the microbial population during biodegradation of the test substance, after correction using a blank, is expressed as % of the ThOD (Theoretical Oxygen Demand).

TABLE 16

| Example | 28 days (%) | 56 days (%) |
|---|---|---|
| 1 | 37 | 73 |
| 2 | 29 | 68 |
| 3 | 23 | 41 |
| 4 | 18 | 41 |
| 5 | 48 | 82 |
| 6 | 22 | 41 |
| 7 | 41 | n.a. |
| 8 | 22 | 46 |
| 9 | 39 | n.a. |
| 10 | 28 | 32 |
| 11 | 27 | n.a. |
| 12 | 20 | 22 |
| 13 | 22 | n.a. |
| 15 | 38 | n.a. |
| 16 | 53 | 56 |
| 17 | 46 | n.a. |

The test results show that the carboxymethylated lysine-based polymer according to the present invention shows acceptable biodegradability.

### Example 18

A 500 ml four-neck flask equipped with a stirrer, an internal thermometer, a gas inlet tube, a condenser with reduced-pressure connection and a Dean-Stark receiver, was charged with 82.5 g of L-lysine, 9.4 g of tartaric acid and 90 g water. The mixture was heated with stirring to an internal temperature of 160° C. After a reaction time of 2 h 25 min, water was distilled off further under reduced pressure (670 mbar). Finally, 94 g of water distillate was collected and the highly viscous polymer was discharged to a silicone container as fast as possible while it was still hot and flowable. K-value was measured to be 11.6. The molar ratio of lysine structural units and tartaric acid structural units is 95:05, as determined by ¹H NMR.

A 250 ml four-neck flask equipped with a stirrer, an internal thermometer, a gas inlet tube, a condenser, was charged with 50 g polylysine copolymer, 29.0 g acrylic acid and 80 g D.I water. The pH of the mixture was nearly 3. Slight pH adjustments to precisely 3 can be made by adding small amounts of either HCl (1 mol/L) or NaOH solutions (1 mol/L). The mixture was then heated with stirring to an internal temperature of 70° C. for 24 h. After the reaction mixture was cooled down to 25° C., the modified polymer was precipitated with excess acetone (1:10 by weight). After three successive precipitation steps, the supernatant was transparent and colorless and the precipitate was dried over 48 h in a vacuum oven at 40° C. to obtain the final product. The solid content was 100% and the active content 96.4 wt %, as determined by ¹H NMR. The degree of modification (DM) of the polymer as determined by ¹H NMR was 29%, and the molecular weights as determined were Mₙ=1,047 g/mol and M_{w}=1,590 g/mol.

### Example 19

A 500 ml four-neck flask equipped with a stirrer, an internal thermometer, a gas inlet tube, a condenser with reduced-pressure connection and a Dean-Stark receiver, was charged with 250 g of L-lysine, 30 g of tartaric acid and 120 g water. The mixture was heated with stirring to an internal temperature of 160° C. After a reaction time of 2 h 25 min, water was distilled off further under reduced pressure (670 mbar). Finally, 127 g of water distillate was collected and the highly viscous polymer was discharged to a silicone container as fast as possible while it was still hot and flowable. K-value was measured to be 10.9. The molar ratio of lysine structural units and tartaric acid structural units is 95:05, as determined by ¹H NMR.

A 250 ml four-neck flask equipped with a stirrer, an internal thermometer, a gas inlet tube, a condenser, was charged with 50 g polylysine copolymer, 29.0 g acrylic acid and 80 g D.I water. The pH of the mixture was nearly 3. Slight pH adjustments to precisely 3 can be made by adding small amounts of either HCl (1 mol/L) or NaOH solutions (1 mol/L). The mixture was then heated with stirring to an internal temperature of 70° C. for 24 h. After the reaction mixture was cooled down to 25° C., the modified polymer was precipitated with excess acetone (1:10 by weight). After three successive precipitation steps, the supernatant was transparent and colorless and the precipitate was dried over 48 h in a vacuum oven at 40° C. to obtain the final product. The solid content was 100% and the active content 96.1 wt %, as determined by ¹H NMR. The degree of modification (DM) of the polymer as determined by ¹H NMR was 33%, and the molecular weights as determined were Mₙ=995 g/mol and M_{w}=1,425 g/mol.

### Example 20

A 500 ml four-neck flask equipped with a stirrer, an internal thermometer, a gas inlet tube, a condenser with reduced-pressure connection and a Dean-Stark receiver, was charged with 250 g of L-lysine, 30 g of tartaric acid and 120 g water. The mixture was heated with stirring to an internal temperature of 160° C. Finally, 125 g of water distillate was collected and the highly viscous polymer was discharged to a silicone container as fast as possible while it was still hot and flowable. K-value was measured to be 10.3. The molar ratio of lysine structural units and tartaric acid structural units is 92:08, as determined by ¹H NMR.

A 500 ml four-neck flask equipped with a stirrer, an internal thermometer, a gas inlet tube, a condenser, was charged with 80 g polylysine copolymer, 56.7 g acrylic acid and 135 g D.I water. The pH of the mixture was nearly 3. Slight pH adjustments to precisely 3 can be made by adding small amounts of either HCl (1 mol/L) or NaOH solutions (1 mol/L). The mixture was then heated with stirring to an internal temperature of 70° C. for 24 h. After the reaction mixture was cooled down to 25° C., the modified polymer was precipitated with excess acetone (1:10 by weight). After three successive precipitation steps, the supernatant was transparent and colorless and the precipitate was dried over 48 h in a vacuum oven at 40° C. to obtain the final product. The solid content was 100% and the active content 99.3 wt %, as determined by ¹H NMR. The degree of modification (DM) of the polymer as determined by ¹H NMR was 51%, and the molecular weights as determined were Mₙ=1,060 g/mol and M_{w}=1,481 g/mol.

### Comparative Example 1

A 500 ml four-neck flask equipped with stirrer, internal thermometer, gas inlet tube, condenser with reduced-pressure connection and receiver, was charged with 200 g of lysine, 22.82 g of tartaric acid and 108 g of DI water. The mixture was heated with stirring to an internal temperature of 160° C. for 2 h 50 min, with continuous water separation. When 108 g distilled water was collected, additional 28.52 g of tartaric acid was introduced into the reactor. After a total reaction time of 3 h 50 min, water was distilled off further under reduced pressure (900 mbar). Finally, 131 g of water distillate had been collected and the highly viscous polymer was discharged to a silicone container as fast as possible, while it was still hot and flowable. The k-value of the lysine was determined as 12.1. The molar ratio of lysine structural units and tartaric acid structural units is 83:17, as determined by ¹H NMR.

A 2000 ml four-neck flask equipped with a stirrer, an internal thermometer, a gas inlet tube, a condenser, was charged with 145.6 g sodium chloroacetate, 175 g polylysine copolymer and 480 g D.I. water. Then, the solution was heated up to 70° C. for 5 h. Meanwhile, pH was maintained at 10 by controlled addition of 48% wt. aqueous NaOH solution, using a control unit of Systag FlexyPat automated lab reactor, equipped with a membrane pump and a pH probe with high temperature electrolyte. After the reaction mixture was cooled down to 30° C., the modified polymer was precipitated with excess methanol (1:10 by weight) and filtered. Upon three successive precipitation steps, the product was dried over 16 hours in a vacuum oven at 40° C. to obtain the final product having a solid content of 100%, and an active content of 96.8 wt % as determined by ¹H NMR. The degree of modification (DM) of the polymer as determined by 1H NMR was 45%, and the molecular weights as determined were Mₙ=1,045 g/mol and M_{w}=1,820 g/mol.

### Comparative Example 2

A 500 ml four-neck flask equipped with a stirrer, an internal thermometer, a gas inlet tube, a condenser with reduced-pressure connection and a Dean-Stark receiver, was charged with 82.5 g of L-lysine, 9.4 g of tartaric acid and 90 g water. The mixture was heated with stirring to an internal temperature of 160° C. After a reaction time of 2 h 25 min, water was distilled off further under reduced pressure (670 mbar). Finally, 94 g of water distillate was collected and the highly viscous polymer was discharged to a silicone container as fast as possible while it was still hot and flowable. K-value was measured to be 11.6. The molar ratio of lysine structural units and tartaric acid structural units is 91:9, as determined by ¹H NMR.

A 250 ml four-neck flask equipped with a stirrer, an internal thermometer, a gas inlet tube, a condenser, was charged with 18.08 g of sodium chloroacetate, 27.5 g of the lysine copolymer and 70 g of DI water. Then, the solution was heated up to 70° C. for 5 hours. Meanwhile, pH was maintained at 10 by controlled addition of 48 wt % aqueous NaOH solution, using a control unit of Systag FlexyCube automated lab reactor, equipped with a peristaltic pump and a pH probe with high temperature electrolyte. After the reaction mixture was cooled down to 30° C. and the modified polymer was precipitated with excess methanol (1:10 by weight) and filtered. Upon three successive precipitation steps, the product was dried over 16 hours in a vacuum oven at 40° C. to obtain the final product having a solid content of 100% and an active content of 97.6%. The degree of modification (DM) of the polymer as determined by ¹H NMR was 32%, and the molecular weights as determined were Mn=1,018 g/mol and Mw=1,547 g/mol.

### Comparative Example 3

A 500 ml four-neck flask equipped with a stirrer, an internal thermometer, a gas inlet tube, a condenser with reduced-pressure connection and a Dean-Stark receiver, was charged with 100 g of an aqueous solution of L-lysine (50 wt %). The mixture was heated with stirring to an internal temperature of 160° C. for 45 minutes. Then, an aqueous solution of 400 g of L-lysine (50 wt %) was dosed constantly over 3.5 hours with continuous water separation. After a reaction time of 1 hour, water was distilled off further under reduced pressure (670 mbar). Finally, 259 g of water distillate was collected and the highly viscous polymer was discharged to a silicone container as fast as possible while it was still hot and flowable. The k-value of the lysine homopolymer was determined as 10.6.

A 250 ml four-neck flask equipped with a stirrer, an internal thermometer, a gas inlet tube, a condenser, was charged with 3.93 g of sodium chloroacetate, 18.75 g of the lysine homopolymer and 56.25 g of DI water. Then, the solution was heated up to 70° C. for 5 hours. During the first 1.5 hours, 15.72 g of sodium chloroacetate and 13.5 g of sodium hydroxide (50 wt %) were added into the flask in 3 portions, every 0.5 hours. After the reaction mixture was cooled down to 30° C., the modified polymer was precipitated with excess methanol (1:10 by weight) and filtered. Upon three successive precipitation steps, the product was dried over 16 hours in a vacuum oven at 40° C. to obtain the final product having a solid content of 100%, and an active content of 94 wt % as determined by ¹H NMR. The degree of modification (DM) of the polymer as determined by 1H NMR was 45%, and the molecular weights as determined were Mn=1,067 g/mol and Mw=1,619 g/mol.

### Comparative Example 4

A 1000 ml four-neck flask equipped with a stirrer, an internal thermometer, a gas inlet tube, a condenser, was charged with 104.65 g of sodium chloroacetate, 50 g of linear ¿-polylysine and 154.65 g of DI water. Then, the solution was heated up to 70° C. for 5 hours. Meanwhile, pH was maintained at 10 by controlled addition of 48 wt % aqueous NaOH solution, using a control unit of Systag FlexyCube automated lab reactor, equipped with a peristaltic pump and a pH probe with high temperature electrolyte. After the reaction mixture was cooled down to 30° C., the pH of the solution was adjusted to 4 using aqueous HCl. Then, the modified polymer was precipitated with excess methanol (1:10 by weight) and filtered. Upon three successive precipitation steps, the product was dried over 16 hours in a vacuum oven at 40° C. to obtain the final product having a solid content of 100% and an active content of 84%. The degree of modification (DM) of the polymer as determined by ¹H NMR was 86%, and the molecular weights as determined were Mn=10,864 g/mol and Mw=11,384 g/mol.

### Application Tests

### IV. Anti-Greying Test

### Test 1:

A laundering process was simulated in lab using a Terg-o-meter (RHLG-IV, from Shanghai Bank Equipment Co. Ltd, China), which includes 12 barrels with respective rotor blades as washing units, generally following GBT 13174-2008. The washing units were operated at the same stirring speed of 120 rotation per minute (rpm) and each contained 1 L washing liquor. White test fabrics were washed in the same barrel together with together with 10 g yellow clay and oil mixtures at 30° C., in a wash liquor comprising a detergent formulation as shown in Table 17. After the washing, the fabrics were removed from the washing units, drained and rinsed twice in 10 L tap water for 30 seconds and dried in air. The details of the wash cycles are summarized in Table 18.

The anti-greying performance was characterized by the difference in remission of a fabric before washing (R_{before}) and after washing (R_{after}), by measuring the fabric with the spectrophotometer Elrepho 2000 from Datacolor at 457 nm.

The difference in remission (ΔR) is calculated in accordance with following equation:

ΔR=R_{before}−R_{after}.

The smaller the value of ΔR, the better the performance.

TABLE 17
Detergent Formulation

| Ingredient | Amount^{a)}, wt % |
|---|---|
| Anionic Surfactant LAS | 5.5 |
| Anionic Surfactant AES | 5.4 |
| Non-ionic Surfactant A7N^{b)} | 5.4 |
| 1,2 propylene glycol | 6 |
| Ethanol | 2 |
| KOH | 1.6 |
| Additive as shown in Table 19 | 1.0 |
| Water | up to 100 |

^{a)}on a basis of active content for all ingredients
^{b)}C₁₂-C₁₄ fatty alcohol ethoxylate (7EO), commercially available from BASF.

TABLE 18

| | |
|---|---|
| Equipment | Terg-O-meter |
| Detergent dosage | 2 g/L |
| Detergent | Formulation as shown in Table 17 |
| Water hardness | 2.5 mmol/L |
| Ca:Mg | 3:2 |
| Washing temperature | 30° C. |
| Wash cycles | 1 (30 min) |
| Wash liquor | 1000 ml |
| White test fabric (3 pieces | Cotton: WFK 10A, WFK 80A, WFK 12A; |
| for each, each 6 × 6 cm) | PES/Cotton blend: WFK 20A; Polyester: |
| | WFK 30A |
| Test soil | 10 g/L yellow clay and oil mixtures (WFK |
| | soil oily mixture) |
| Rinsing Condition | Tap water directly, max water level (10 L) |
| Dry Condition | Naturally |

TABLE 19

| Additive | ΔR, Sum of all fabrics |
|---|---|
| Blank | 44.87 |
| Modified PEI-2 | 34.27 |
| Polyacrylic acid ^{a)} | 38.46 |
| Example 15 | 35.55 |
| Example 16 | 33.74 |
| Example 17 | 38.53 |

^{a)} Acrylic acid homopolymer (partially neutralized), available from BASF.

### Test 2:

A laundering process was simulated in lab using a Terg-o-meter (Testfabrics, Inc., West Pittston, Pennsylvania, USA) generally following ASTM D4008-16. Several white test swatches were washed together with 0.5 g Georgia red clay (solid particulate) at 30° C. in a washing liquor, containing the liquid detergent formulation detailed in Table 20, with the selected polymers. After the wash, the test fabrics were rinsed and rung-dried by hand. This wash cycle was repeated three times (for a total of four) with fresh Georgia red clay and new wash liquor. After the fourth wash the test fabrics were rinsed, spin-dried in wringing machine and dried in a machine dryer for 30 minutes at medium heat setting. The details of the wash cycles are summarized in Table 21. The antiredeposition performance is determined by measuring the the L, a, and b values of the white test fabrics before and after wash with a Konica Minolta spectrophotometer. The ΔE value is then calculated from the resultant values, according to the following equation:

$$Δ E = {( Δ {L}^{* 2} + Δ {a}^{* 2} + Δ {b}^{* 2} )}^{1 / 2}$$

where ΔL*=L*_{washed}−L*ᵢₙᵢₜᵢₐₗ; Δa*=a*_{washed}−a*ᵢₙᵢₜᵢₐₗ; and Δb*=b*_{washed}−b*ᵢₙᵢₜᵢₐₗ. The smaller the ΔE value, the better is the performance.

TABLE 20
Detergent Formulation

| Ingredient | Amount^{a)}, wt % |
|---|---|
| Anionic Surfactant SDBS-40 | 6.72 |
| Anionic surfactant SLES ^{b)} | 12.5 |
| Non-ionic surfactant ^{c)} | 6.24 |
| Emery ® 622 | 1.80 |
| NaOH (50%) | 0.33 |
| Na Citrate 2H₂O | 2.99 |
| Propylene Glycol | 6.00 |
| Ethanol | 2.00 |
| Additive as shown in Table 22 | 1.0 or 2.0 |
| Water | up to 100 |

^{a)}on a basis of active content for all ingredients
^{b)} Fatty alcohol ethersulfate, commercially available from BASF
^{c)} Lauryl alcohol ethoxylate, commercially available from BASF

TABLE 21

| | |
|---|---|
| Equipment | Terg-O-meter |
| Washing liquor | 1000 ml |
| Washing time, temperature | 20 min at 30° C. |
| Rinsing Time, Temperature | 3 min at 15° C. |
| Detergent Dosage | 1 g/L |
| Washing cycles | 4 |
| Water hardness | 1.5 mmol/l with Ca²⁺:Mg²⁺:HCO₃⁻ - 4:1:8 |
| Soiling with | 0.5 g Georgia Red Clay |
| Test fabrics | Terry cotton: WFK 12 A (3 pieces each, |
| | each 11.43 × 11.43 cm) |
| | Cotton: TF 400 (6 pieces each, each 7.62 × |
| | 10.16 cm) Polyester/cotton blend 65/35: TF |
| | 7409 (6 pieces each, each 7.62 × 10.16 cm) |

TABLE 22

| Additive | |
|---|---|
| ΔE, Sum of | ΔE, Sum of |
| all fabrics | cotton fabrics |

| | | | | |
|---|---|---|---|---|
| Polymer content | 1% | 2% | 1% | 2% |

| | | |
|---|---|---|
| Blank Batch | 45.76 | 9.82 |

| | | | | |
|---|---|---|---|---|
| PEI alkoxylate blend | 31.1 | 16.64 | 10.28 | 3.62 |
| (available from BASF) | | | | |
| Maltodextrin-graft | 27.62 | n.a. | 3.12 | n.a. |
| Polyacrylic acid (PAA) | | | | |
| (available from BASF) | | | | |
| Example 5 | 22.68 | 12.76 | 4.78 | 1.34 |
| Example 6 | 14.12 | 11.74 | 1.86 | n.a. |
| Example 7 | 39.38 | 35.84 | 6.26 | 5.34 |
| Example 8 | 31.32 | 16.44 | 9.22 | 2.16 |
| Example 14 | 29.24 | 26.86 | 4.44 | n.a. |
| Example 15 | 12.62 | n.a. | 1.64 | n.a. |
| Example 17 | 20.86 | n.a. | 2.74 | n.a. |
| Example 18 | 26.3 | 15.16 | 4.14 | 3.26 |
| Example 19 | 29.08 | 21.44 | 3.96 | 1.54 |
| Example 20 | 28.46 | 25.82 | 5.02 | 3.34 |
| Comparative Example 1 | 44.78 | 33.20 | 14.46 | 6.38 |
| Comparative Example 2 | 30.84 | 20.18 | 6.94 | 5.98 |
| Comparative Example 3 | 30.58 | 30.34 | 10.88 | 6.54 |

### Test 3:

A laundering process was simulated with Launder-o-meter (LP2 Typ, SDL Atlas Inc., USA). The details of the wash cycles are summarized in Table 23. White test fabrics were washed in the same beaker together with 2.5 g EMPA101 and 2.5 g SBL 2004 and 20 steel balls at 30° C. in a wash liquor comprising a detergent with the formulation as shown in Table 24, and then rinsed and spin-dried for completing a wash cycle. The wash cycle was repeated two times with new clay dispersion and new wash liquor. After the rinsing in the third wash cycle, the test fabrics were dried in air instead.

The anti-greying performance was characterized by Remission R value of the soiled fabric before and after wash and determined by measuring the fabric with the spectrophotometer Elrepho 2000 from Datacolor at 460 nm. The higher the Remission R value, the better is the performance. Results were summarized in Table 25.

TABLE 23

| | |
|---|---|
| Equipment | Launder-o-meter |
| Detergent dosage | 2 g/L |
| Detergent | Formulation as shown in Table 24 |
| Water hardness | 2.5 mmol/L, Ca²⁺:Mg²⁺:HCO₃⁻ 4:1:8 |
| Ca:Mg:HCO3⁻ | 4:1:8 |
| Washingtemperature | 30° C. |
| Wash cycles | 3 (each 20 min) |
| Wash liquor | 250 ml |
| Equipment | Launder-o-meter |
| Fabric/liquor ratio | 1 kg/10 L |
| White test fabric | Cotton: wfk10A, wfk80A, wfk 12A, EMPA 221, |
| (each 10 × 10 cm) | T-shirt PES/Co blend: wfk20A |
| | Polyester: wfk30A |
| | Polyamid: EMPA 406 |
| Test soil | 2.5 g EMPA101 and 2.5 g SBL 2004 |

TABLE 24
Detergent Formulation

| Ingredient | Amount^{a)}, wt % |
|---|---|
| Anionic Surfactant DBS/LC ^{b)} | 5.5 |
| Edenor ® K12-18 | 2.4 |
| Anionic Surfactant AES | 5.4 |
| NaOH | 2.2 |
| Non-ionic Surfactant AEO-1 | 5.4 |
| 1,2-Propylene glycol | 6.0 |
| Ethanol | 2.0 |
| Sodium citrate | 3.0 |
| Additive as shown in Table 25 | 3.0 |
| Water | up to 100 |

^{a)}on a basis of active content for all ingredients/on a basis of solid content for a polymeric ingredient
^{b)} Linear alkylbenzene sulfonate Maranil DBS/LC (BASF)

TABLE 25

| Additive | R, Sum of all fabrics |
|---|---|
| Blank | 540.2 |
| Example 12 | 567.0 |

### Detergency Performance

### Test 1:

The primary detergency performance for protease-relevant stains was determined as follows. A laundering process was simulated in lab using a Terg-o-meter (Testfabrics, Inc., West Pittston, Pennsylvania, USA). A mixture of fabrics soiled with standardized stains were washed together amongst 30 g of unsoiled, ballast fabric at 30° C. in a washing liquor containing the liquid detergent formulation of Table 26, with or without the presence of enzyme. After the wash cycle, the test fabrics and ballast were rinsed and spin-dried in a wringing machine. The stain swatches were then separated from the ballast fabrics, covered from light and hung-dried. The details of the washing process are summarized in Table 27.

The primary detergency is determined by measuring the L, a, and b values of the soiled test fabrics before and after wash with a Mach5+ Colour Consult spectrophotometer from Center for Testmaterials. The ΔE value is then calculated from the resultant pre- and post-wash values, in accordance with following equation:

$$Δ E = {( Δ {L}^{* 2} + Δ {a}^{* 2} + Δ {b}^{* 2} )}^{1 / 2} where$$

$$Δ {L}^{⋆} = {L}_{w a s h e d}^{⋆} - {L}_{i n i tial}^{⋆} ; Δ {a}^{⋆} = {a}_{w a s h e d}^{⋆} - {a}_{i n i tial}^{⋆} ; and Δ {b}^{⋆} = {b}_{w a s h e d}^{⋆} - {b}_{i n i tial}^{⋆} .$$

The higher the ΔE value, the better is the performance. Table 28 shows the detergency performance of different polymeric additives in the absence and presence of a laundry protease.

TABLE 26
Detergent Formulation

| Ingredient | Amount^{a)}, wt % |
|---|---|
| Anionic Surfactant SDBS-40 | 6.72 |
| Anionic surfactant SLES | 12.5 |
| Non-ionic surfactant LA 60 | 6.24 |
| Emery 622 | 1.80 |
| NaOH (50%) | 0.33 |
| Na Citrate 2H₂O | 2.99 |
| Propylene Glycol | 6.00 |
| Ethanol | 2.00 |
| Laundry protease (available from BASF) | 0 or 1.0 |
| Additive as shown in Table 28 | 1.0 |
| Water | up to 100 |

^{a)}on a basis of active content for all ingredients

TABLE 27

| | |
|---|---|
| Test equipment | Terg-O-meter |
| Washing liquor | 1000 ml |
| Washing time, temperature | 20 min at 30° C. |
| Rinsing time, temperature | 3 min at 15° C. |
| Detergent Dosage | 1 g/L |
| Washing cycles | 1 |
| Water hardness | 1.1 mmol/l with Ca²⁺:Mg²⁺:HCO₃⁻ - 4:1:8 |
| Sum test fabrics | Multisoil monitors for protease-relevant stains, 2 replicates |
| | Blood/milk/ink (SWI-E-116) on Cotton woven |
| | Blood/milk/ink (SWI-E-117) on PES: Cotton 65:35 |
| | Blood, hardset (SS-2201026) on Cotton |
| | Blood, hardset (SS-2202026) on Blend |
| | Full egg with pigment aged (CFT-C-S-39) on Cotton woven |
| | Cocoa (SWI-E-112) on Cotton woven |
| | Chocolate milk (CFT-C-03) on Cotton woven |
| | Grass (SS-2201054) on Cotton |
| White ballast fabrics | WFK 10 A, (3 pieces each, each 7.62 x 10.16 cm) |
| | WFK 12 A, (2 pieces each, each 11.43 x 11.43 cm) |
| | WFK 20 A, (3 pieces each, each 7.62 x 10.16 cm) |

TABLE 28

| | ΔE, Sum of | ΔE, Sum of |
|---|---|---|
| | stained fabrics | stained fabrics |
| | with protease | with protease |
| | stains, no | stains, with |
| Additive | protease | protease |
| Blank | 84.31 | 135.56 |
| Modified PEI-2 | 92.33 | 140.65 |
| Maltodextrin-graft- | 78.91 | 139.08 |
| Polyacrylic acid (PAA) | | |
| Example 5 | 85.88 | 145.72 |
| Example 17 | 86.42 | 143.89 |

### Test 2:

A laundering process was simulated with Launder-o-meter (LP2 Typ, SDL Atlas Inc., USA), using the liquid laundry formulation in Table 29 and in accordance with the protocol as described in Table 30. Soil monitors were used for evaluation of the detergency for outdoor and fatty stains.

TABLE 29
Detergent Formulation

| Ingredient | Amount^{a)}, wt % |
|---|---|
| Anionic Surfactant DBS/LC | 5.5 |
| Edenor ® K12-18 | 2.4 |
| Anionic Surfactant AES | 5.4 |
| NaOH | 2.2 |
| Non-ionic Surfactant AEO-1 | 5.4 |
| 1,2-Propylene glycol | 6.0 |
| Ethanol | 2.0 |
| Sodium citrate | 3.0 |
| Additive as shown in Table 31 | 3.0 |
| Water | up to 100 |

^{a)}on a basis of active content for a non-polymeric ingredient and on a basis of solid content for a polymeric ingredient

TABLE 30

| | |
|---|---|
| Equipment | Launder-o-meter |
| Detergent dosage | 3 g/L |
| Detergent | Formulation as shown in Table 29 |
| Water hardness | 1.0 mmol/L for outdoor stains; 2.5 mmol/l for fatty stains, |
| | Ca²⁺:Mg²⁺:HCO₃⁻ 4:1:8 |
| Washing | 30° C. |
| temperature | |
| Wash cycles | 2 |
| Duration of cycle | 20 min for outdoor stains; 60 min for fatty stains |
| Washliquor | 250 ml |
| Fabric/liquor ratio | 1 kg/12.5 L |
| Equipment | Launder-o-meter |
| Test fabric: | Multisoil monitors: |
| | Fatty stains MON-BASF-03: C-S-10 butter fat, C-S-62 lard |
| | colored, C-S-78 soy bean oil, E-112 cocoa, E-141/1 lipstick/ |
| | heavy soil, E-125 oily soils surfactant relevant, W-20D sebum, |
| | C-S-70 chocolate mousse |
| | Outdoor stains MON-BASF-13: PC-H144 red pottery clay, KC- |
| | H115 standard clay, P-H145 tenniscourt clay, KC-H018 ground |
| | soil |
| Ballast fabric | 10 g cotton fabric from Reichenbach |

The primary detergency is characterized by ΔE value calculated according to DIN EN ISO 11664-4 (June 2012) in accordance with following equation:

$$Δ E = {( Δ {L}^{* 2} + Δ {a}^{* 2} + Δ {b}^{* 2} )}^{1 / 2} ,$$

$$in which$$

$$Δ {L}^{⋆} = {L}_{w a s h e d}^{⋆} - {L}_{initial}^{*} ; Δ {a}^{⋆} = {a}_{w a s h e d}^{⋆} - {a}_{initial}^{⋆} ; and Δ b = {b}_{w a s h e d}^{⋆} - {b}_{initial}^{⋆} .$$

The L*, a*, b* values were measured on the stained fabrics before and after washing with the spectrophotometer MACH 5 from Colour Consult provided by CFT, NL-Vlaardingen. The higher the ΔE value, the better is the performance.

Characterization by ΔE was performed twice and the average value was given as the test result. The higher the ΔE value, the better is the performance. The Test results are summarized in Table 31.

TABLE 31

| | ΔE, Sum of stained | ΔE, Sum of stained |
|---|---|---|
| | fabrics with | fabrics with |
| Additive | outdoor stains | fatty stains |
| Blank | 165.7 | 178.8 |
| Example 13 | 170.7 | 182.4 |
| Comparative Example 4 | 169.7 | 179.4 |

### V Biodegradablity

The biodegradability is measured by using the abovementioned method. The results are listed in Table 32.

TABLE 32

| | 28 days (%) | 56 days (%) |
|---|---|---|
| Example 7 | 41 | 52 |
| Example 16 | 53 | 56 |
| Example 17 | 46 | — |
| Example 18 | 9 | 25 |
| Example 19 | 13 | 25 |
| Example 20 | 29 | 68 |

The invention claimed is:

1. A modified lysine-based polymer obtained from a process including Michael addition of at least a portion of free amino groups in a lysine-based polymer with a Michael acceptor selected from the group consisting of at least one of unsaturated carboxylic acids and unsaturated carboxylic acid esters.

2. The modified lysine-based polymer according to claim 1, wherein the Michael acceptor is at least one selected from the group consisting of α,β-ethylenically unsaturated monocarboxylic acids having 3 to 10 carbon atoms, α,β-ethylenically unsaturated dicarboxylic acids having 4 to 8 carbon atoms, α,β-ethylenically unsaturated tricarboxylic acids having 4 to 8 carbon atoms, α,β-ethylenically unsaturated carboxylic acids having more carboxylic acid groups, and any esters thereof.

3. The modified lysine-based polymer according to claim 2, wherein the Michael acceptor is at least one selected from the group consisting of acrylic acid, methacrylic acid, maleic acid, fumaric acid, crotonic acid, itaconic acid, citraconic acid, mesaconic acid, glutaconic acid, aconitic acid, and any esters thereof.

4. The modified lysine-based polymer according to claim 3, wherein the Michael acceptor is at least one selected from the group consisting of acrylic acid, maleic acid, itaconic acid, and any esters thereof.

5. The modified lysine-based polymer according to claim 1, wherein the esters are selected the group consisting of from polyalkylene oxide esters or terminated polyalkylene oxide esters of the unsaturated carboxylic acids, and a combination thereof.

6. The modified lysine-based polymer according to claim 1, wherein the terminated polyethylene oxide esters contain a terminating group selected from the group consisting of C₁-C₄-alkyl and C₁-C₄-hydroxyalkyl.

7. The modified lysine-based polymer according to claim 5, wherein moieties of the polyalkylene oxide or terminated polyalkylene oxide have a number average molecular weight of from 100 to 2,000.

8. A modified lysine-based polymer, which comprises the structural units from lysine monomer represented by 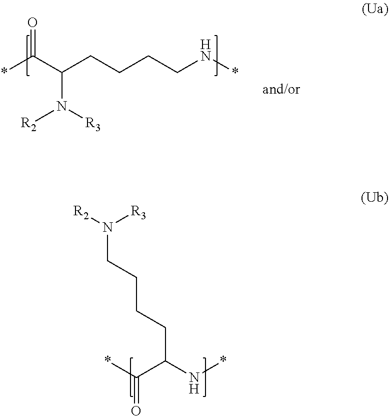
wherein
R₂ and R₃, independently from each other, are selected from the group consisting of H and R₄, provided that at least one of R₂ and R₃ is R₄,
* denotes the position where the structural unit is attached to any other structural units by an amide linkage,
R₄ is a moiety represented by formula (II) 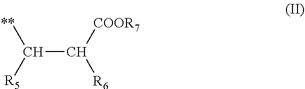
in which
R₅ and R₆ independently from each other are selected from the group consisting of H, C₁-C₆-alkyl, carboxyl (—COOH), —COOM, —(C₁-C₄-alkylene)-COOH and —(C₁-C₄-alkylene)-COOM,
R₇ is selected from the group consisting of H, C₁-C₆-alkyl, —(CH₂CH₂O)ₙ—R₈ and M,
R₈ is C₁-C₄-alkyl,
M is a cation selected from the group consisting of alkali metal cations, alkaline earth metal cations, ammonium and amine cations,
n is a number in a range of from 2 to 40, and
** donates the position where the moiety is attached to the N atom carrying R₄.

9. (canceled)

10. (canceled)

11. (canceled)

12. The modified lysine-based polymer according to claim 1, which is a modified homopolymer of lysine.

13. The modified lysine-based polymer according to claim 1, which is a modified copolymer of lysine comprising more than 50 mol % of structural units from lysine monomer and less than 50 mol % of structural units from at least one dicarboxylic acid or amide-forming derivative thereof.

14. The modified lysine-based polymer according to claim 13, which comprises
(A) 60 to 99 mol % of structural units from lysine monomer, and
(B) 1 to 40 mol % of structural units from at least one dicarboxylic acid of formula (I) or amide-forming derivative thereof
HOOC—R₁—COOH (I)
wherein
R₁ is a direct bond or an aliphatic linear hydrocarbylene, which is unsubstituted or substituted with at least one group selected from the group consisting of unsubstituted or substituted alkyl, unsubstituted or substituted alkoxy, unsubstituted or substituted alkylthio, unsubstituted or substituted alkylamino, di(alkyl)amino, alkylidene, hydroxyl, mercapto, amino and halogen.

15. The modified lysine-based polymer according to claim 14, which comprises (B) structural units from at least one dicarboxylic acid of formula (I) or amide-forming derivative thereof wherein R₁ is a direct bond or an aliphatic linear C₁-C₂₄-hydrocarbylene which is unsubstituted or substituted with at least one group selected from the group consisting of unsubstituted or substituted C₁-C₁₈-alkyl, unsubstituted or substituted C₁-C₁₈-alkoxy, unsubstituted or substituted C₁-C₁₈-alkylthio, unsubstituted or substituted C₁-C₁₈-alkylamino, di(C₁-C₁₈-alkyl)amino, C₁-C₆-alkylidene, hydroxyl, mercapto, amino and halogen.

16. (canceled)

17. (canceled)

18. (canceled)

19. (canceled)

20. (canceled)

21. (canceled)

22. (canceled)

23. (canceled)

24. The modified lysine-based polymer according to claim 1, which has a degree of modification via Michael addition of at least 10%.

25. The modified lysine-based polymer according to claim 1, which has a weight average molecular weight (M_{w}) in the range of 600 to 20,000 g/mol, and/or has a number average molecular weight (Mₙ) in the range of 500 to 20,000 g/mol.

26. A detergent composition which comprises the modified lysine-based polymer according to claim 1.

27. (canceled)

28. The detergent composition according to claim 25, which comprises 2-phenoxyethanol.

29. The detergent composition according to claim 25, which comprises 4,4′-dichloro-2-hydroxydiphenylether.

30. The detergent composition according to claim 26, which comprises at least one enzyme.

31. A method of using the modified lysine-based polymer as according to claim 1, the method comprising using the modified lysine-based polymer in a detergent composition.

32. A method of using the modified lysine-based polymer according to claim 1, the method comprising using the modified lysine-based polymer as a dispersing agent.

33. A method of preserving an aqueous detergent composition comprising the modified lysine-based polymer according to claim 1 against microbial contamination or growth, which comprises adding 2-phenoxyethanol in the detergent composition.

34. A method of laundering fabric or cleaning hard surfaces, which comprises an antimicrobial treatment of a fabric or a hard surface with a detergent composition comprising the modified lysine-based polymer according to claim 1 and 4,4′-dichloro-2-hydroxydiphenylether.
